(19) United States
(12) Patent Application Publication
(10) Pub. No.: US 2026/0245282 A1
(43) Pub. Date: Aug. 20, 2026

(54) QUAD COMPRESSION FOR PIXEL SHADING

(71) Applicant: QUALCOMM Incorporated, San Diego, CA (US)

(72) Inventors: Piyush GUPTA, Bangalore (IN); Sharad RAJ, Bengaluru (IN); Shariq HASNAIN, Bengaluru (IN); Iman Kalyan MAITY, Belda (IN)

(21) Appl. No.: 19/054,659

(22) Filed: Feb. 14, 2025

(51) Int. Cl. G06T 15/00; G06T 9/00

(52) U.S. Cl. CPC G06T 15/005; G06T 9/00; G06T 2210/52

(57) ABSTRACT

Aspects presented herein relate to methods and devices for graphics processing including an apparatus, e.g., a graphics processor. The apparatus may obtain an indication of a set of quadrants for at least one draw call in a set of draw calls associated with a frame, where each of the set of quadrants includes a plurality of pixels in the frame. The apparatus may also compress at least two quadrants in the set of quadrants based on a set of conditions associated with the set of quadrants, or refrain from compressing the at least two quadrants in the set of quadrants based on the set of conditions associated with the set of quadrants. Further, the apparatus may output an indication of the compression of the at least two quadrants or the refrainment from the compression of the at least two quadrants.

### TECHNICAL FIELD

The present disclosure relates generally to processing systems and, more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor or display processing unit (DPU).

A graphics processor of a device may be configured to perform the processes in a graphics processing pipeline. Further, graphics processors may be utilized to perform graphics rendering. However, there has developed an increased need for improved rendering in graphics processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a graphics processing unit (GPU), a graphics processor, a central processing unit (CPU), a compiler, or any apparatus that may perform for graphics processing. The apparatus may obtain an indication of a set of quadrants for at least one draw call in a set of draw calls associated with a frame, where each of the set of quadrants includes a plurality of pixels in the frame. The apparatus may also determine whether each of a set of conditions associated with the set of quadrants is met, where a compression of at least two quadrants or a refrainment from compression of the at least two quadrants is based on the determination. The apparatus may also determine whether to compress the at least two quadrants in the set of quadrants based on each of the set of conditions associated with the set of quadrants being met. Additionally, the apparatus may compress at least two quadrants in the set of quadrants based on a set of conditions associated with the set of quadrants, or refrain from compressing the at least two quadrants in the set of quadrants based on the set of conditions associated with the set of quadrants. The apparatus may also adjust a capacity of at least one memory based on the compression of the at least two quadrants or the refrainment from the compression of the at least two quadrants. Moreover, the apparatus may configure a compression buffer based on the compression of the at least two quadrants or the refrainment from the compression of the at least two quadrants. The apparatus may also store, in the compression buffer, data for the at least two quadrants based on the compression of the at least two quadrants or the refrainment from the compression of the at least two quadrants. The apparatus may also output an indication of the compression of the at least two quadrants or the refrainment from the compression of the at least two quadrants.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system in accordance with one or more techniques of this disclosure.

FIG. 2 illustrates an example graphics processing unit (GPU) in accordance with one or more techniques of this disclosure.

FIG. 3 is a diagram illustrating example processing components in accordance with one or more techniques of this disclosure.

FIG. 4 is a diagram illustrating an example image or surface in accordance with one or more techniques of this disclosure.

FIG. 5 is a diagram illustrating an example geometry pipeline in accordance with one or more techniques of this disclosure.

FIG. 6 is a diagram illustrating an example GPU hardware in accordance with one or more techniques of this disclosure.

FIG. 7 is a diagram illustrating an example execution sequence in accordance with one or more techniques of this disclosure.

FIG. 8 is a diagram illustrating an example graphics pipeline in accordance with one or more techniques of this disclosure.

FIG. 9 is a diagram illustrating an example of quadrant (quad) pixel shading in accordance with one or more techniques of this disclosure.

FIG. 10 is a graph illustrating example hole percentages in accordance with one or more techniques of this disclosure.

FIG. 11 is a diagram illustrating an example of a compression abortion process in accordance with one or more techniques of this disclosure.

FIG. 12 is a diagram illustrating an example of quadrant (quad) pixel shading in accordance with one or more techniques of this disclosure.

FIG. 13 is a graph illustrating example hole percentages in accordance with one or more techniques of this disclosure.

FIG. 14 is a diagram illustrating an example quad compression process in accordance with one or more techniques of this disclosure.

FIG. 15 is a communication flow diagram illustrating example communications between a GPU, a GPU/CPU, and a memory in accordance with one or more techniques of this disclosure.

FIG. 16 is a flowchart of an example method of graphics processing in accordance with one or more techniques of this disclosure.

FIG. 17 is a flowchart of an example method of graphics processing in accordance with one or more techniques of this disclosure.

### DETAILED DESCRIPTION

In some aspects, shader instructions may be executed by a GPU component, such as

a shader processor (SP). More specifically, shader instructions may be executed in single instruction multiple data (SIMD) fashion in a GPU component called a shader processor (SP). Shader processors may be an arithmetic logic unit (ALU)-heavy component and provide the parallelism to the GPU. Accordingly, the shader processor may be referred to as the powerhouse of the GPU. There may be many SPs within the GPU, and each SP may be composed of multiple ALUs. Also, each SP may be able to launch multiple threads called fibers. For instance, one thread (also referred to as a fiber) may execute the pixel shader for one pixel. A collection or group of fibers may be called a wave. Further, all fibers belonging to a wave may execute in single instruction multiple data (SIMD) fashion. Additionally, each fiber may shade one pixel during pixel shader execution. Pixel shader instructions may be executed within the wave in SIMD fashion, where each fiber may belong to a respective wave that executes instructions for each pixel. Moreover, a GPU may schedule pixels in the form of quadrants (quads) after rasterization for pixel shading. In some instances, one fiber of a shader processor may be assigned to one pixel of the quad. Further, a wave may contain multiple quads. Also, quads can be partially covered (i.e., not all 4 pixels of a quad contain a valid pixel for pixel shading). When a quad is partially covered, this may decrease the ALU utilization because a shader processor may assign a dummy fiber for an uncovered pixel. The amount of holes in major render targets may reduce the ALU utilization. Accordingly, an increase in hole percentage in major render targets may decrease the ALU utilization. ALU utilization may decrease more for small triangle-heavy workloads (e.g., workloads with a large amount of triangles or primitives that are less than a threshold size), such as a DirectX (DX) workload (e.g., an application program interface (API) workload) and advanced rendering techniques (e.g., Gaussian splatting, etc.). Indeed, the issue of a decrease in ALU utilization may be aggravated significantly for small triangle- heavy workloads (e.g., DX workloads or API workloads). Based on the above, it may be beneficial to increase the ALU utilization at a GPU.

Aspects of the present disclosure may include a number of benefits or advantages. Aspects of the present disclosure may increase the ALU utilization at a GPU. Also, aspects presented herein may reduce the number of holes that are processed by a shader processor. That is, aspects presented herein may decrease the number of workloads that include holes that are processed by a shader processor. By doing so, aspects presented herein may increase the ALU utilization at a shader processor. In order to decrease the number of workloads that include holes, aspects presented herein may compress quads that belong to a same location. For example, aspects herein may compress quads that belong to a same location before scheduling the quads for pixel shading. That is, aspects herein may compress quads that correspond to a same pixel or group of pixels before scheduling the quads for pixel shading. For instance, aspects herein may compress at least two quads together that correspond to a same set of pixels before scheduling the quads for pixel shading. By doing so, aspects presented herein may decrease the number of workloads that include holes that are processed by a shader processor, which increases the ALU utilization at a shader processor. In turn, this may optimize or improve the overall performance of a GPU.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as "elements"). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a "processing system" that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term "content" may refer to "graphical content," "image," and vice versa. This is true regardless of whether the terms are being used as an adjective, noun, or other parts of speech. In some examples, as used herein, the term "graphical content" may refer to a content produced by one or more processes of a graphics processing pipeline. In some examples, as used herein, the term "graphical content" may refer to a content produced by a processing unit configured to perform graphics processing. In some examples, as used herein, the term "graphical content" may refer to a content produced by a graphics processing unit.

In some examples, as used herein, the term "display content" may refer to content generated by a processing unit configured to perform displaying processing. In some examples, as used herein, the term "display content" may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended. In some examples, as used herein, the term "graphics workload" may refer to any workload or order associated with graphics processing. In some examples, as used herein, the term "texture fetch" may refer to a memory request, which incurs transactions from a cache (e.g., a texture cache). Each time a warp executes a texture function to read from texture memory, this may be a single texture fetch. Also, texture memory may be read-only device memory, and may be accessed using the device functions described in a texture function. Reading a texture using one of these functions may be called a "texture fetch." A "render target" may refer to a target block of pixels (buffer) into which rendering will occur. In some aspects, a render target may refer to a buffer where the pixels are drawn (e.g., a video card draws pixels) for a scene that is being rendered in the background. An intermediate render target may refer to a render target that is used in post-processing.

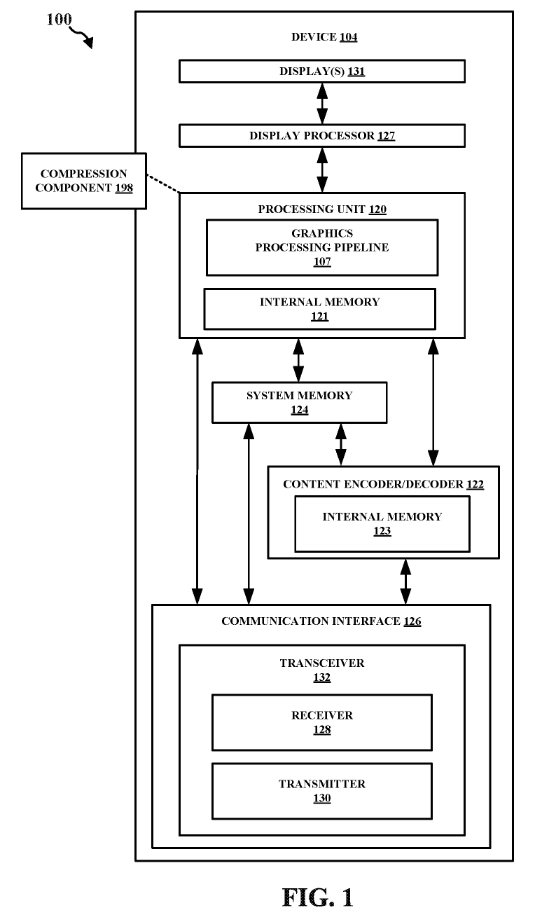

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term "non-transitory" may indicate that the storage medium is not embodied in a carrier wave or a propagated signal. However, the term "non-transitory" should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a compression component 198 configured to obtain an indication of a set of quadrants for at least one draw call in a set of draw calls associated with a frame, where each of the set of quadrants includes a plurality of pixels in the frame. The compression component 198 may also be configured to determine whether each of a set of conditions associated with the set of quadrants is met, where a compression of at least two quadrants or a refrainment from compression of the at least two quadrants is based on the determination. The compression component 198 may also be configured to determine whether to compress the at least two quadrants in the set of quadrants based on each of the set of conditions associated with the set of quadrants being met. The compression component 198 may also be configured to compress at least two quadrants in the set of quadrants based on a set of conditions associated with the set of quadrants, or refrain from compressing the at least two quadrants in the set of quadrants based on the set of conditions associated with the set of quadrants. The compression component 198 may also be configured to adjust a capacity of at least one memory based on the compression of the at least two quadrants or the refrainment from the compression of the at least two quadrants. The compression component 198 may also be configured to configure a compression buffer based on the compression of the at least two quadrants or the refrainment from the compression of the at least two quadrants. The compression component 198 may also be configured to store, in the compression buffer, data for the at least two quadrants based on the compression of the at least two quadrants or the refrainment from the compression of the at least two quadrants. The compression component 198 may also be configured to output an indication of the compression of the at least two quadrants or the refrainment from the compression of the at least two quadrants. Although the following description may be focused on display processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

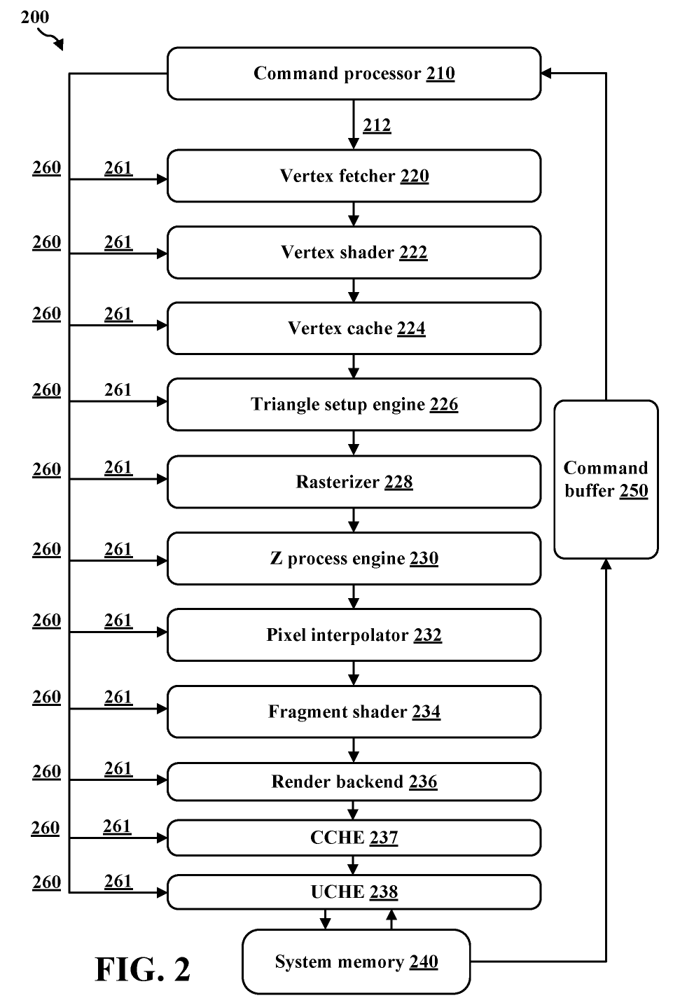

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 1 (L1) cache (cluster cache (CCHE)) 237, level 2 (L2) cache (UCHE) 238, and system memory 240. Although FIG. 2 displays that GPU 200 includes processing units 220- 238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in double data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some types of GPUs may include different types of pipelines, such as a graphics processing pipeline. Graphics processing pipelines may include one or more of a vertex shader stage, a hull shader stage, a domain shader stage, a geometry shader stage, and a pixel shader stage. These stages of the graphics processing pipeline may be considered shader stages. These shader stages may be implemented as one or more shader programs that execute on shader units at a GPU. Shader units may be configured as a programmable pipeline of processing components. In some examples, a shader unit may be referred to as "shader processors" or "unified shaders," and may perform geometry, vertex, pixel, or other shading operations to render graphics. Shader units may include shader processors, each of which may include one or more components for fetching and decoding operations, one or more arithmetic logic units (ALUs) for carrying out arithmetic calculations, one or more memories, caches, and registers.

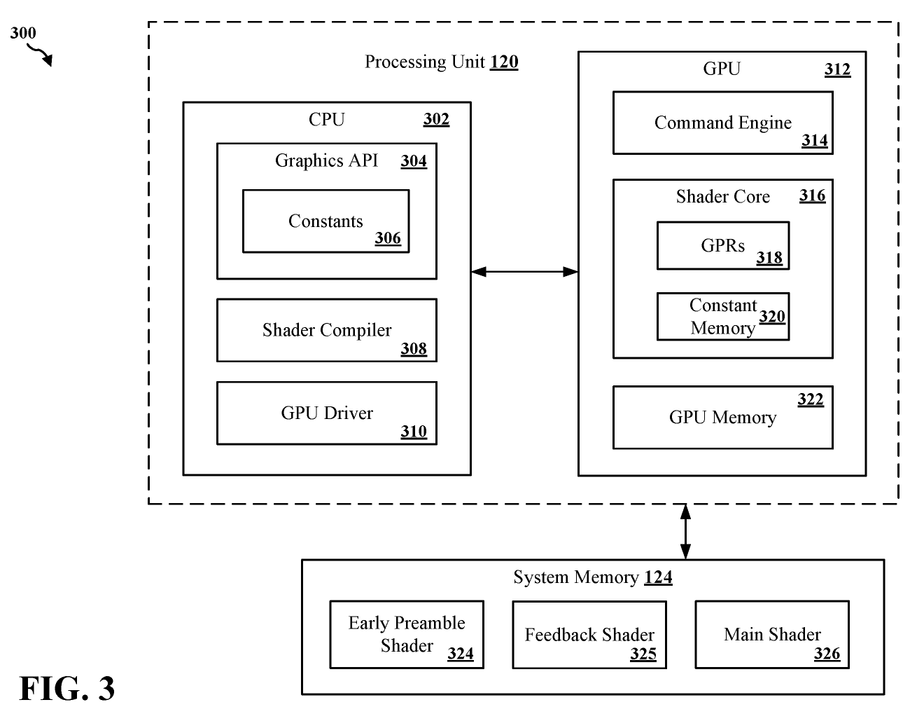

FIG. 3 is a diagram 300 that illustrates processing components, such as the processing unit 120 and the system memory 124, as may be identified in connection with the device 104 for processing data. In aspects, the processing unit 120 may include a CPU 302 and a GPU 312. The GPU 312 and the CPU 302 may be formed as an integrated circuit (e.g., a system-on-a-chip (SOC)) and/or the GPU 312 may be incorporated onto a motherboard with the CPU 302. Alternatively, the CPU 302 and the GPU 312 may be configured as distinct processing units that are communicatively coupled to each other. For example, the GPU 312 may be incorporated on a graphics card that is installed in a port of the motherboard that includes the CPU 302.

The CPU 302 may be configured to execute a software application that causes graphical content to be displayed (e.g., on the display(s) 131 of the device 104) based on one or more operations of the GPU 312. The software application may issue instructions to a graphics application program interface (API) 304, which may be a runtime program that translates instructions received from the software application into a format that is readable by a GPU driver 310. After receiving instructions from the software application via the graphics API 304, the GPU driver 310 may control an operation of the GPU 312 based on the instructions. For example, the GPU driver 310 may generate one or more command streams that are placed into the system memory 124, where the GPU 312 is instructed to execute the command streams (e.g., via one or more system calls). A command engine 314 included in the GPU 312 is configured to retrieve the one or more commands stored in the command streams. The command engine 314 may provide commands from the command stream for execution by the GPU 312. The command engine 314 may be hardware of the GPU 312, software/firmware executing on the GPU 312, or a combination thereof. While the GPU driver 310 is configured to implement the graphics API 304, the GPU driver 310 is not limited to being configured in accordance with any particular API. The system memory 124 may store the code for the GPU driver 310, which the CPU 302 may retrieve for execution. In examples, the GPU driver 310 may be configured to allow communication between the CPU 302 and the GPU 312, such as when the CPU 302 offloads graphics or non-graphics processing tasks to the GPU 312 via the GPU driver 310.

The system memory 124 may further store source code for one or more of an early preamble shader 324, a feedback shader 325, or a main shader 326. In such configurations, a shader compiler 308 executing on the CPU 302 may compile the source code of the shaders 324-326 to create object code or intermediate code executable by a shader core 316 of the GPU 312 during runtime (e.g., at the time when the shaders 324-326 are to be executed on the shader core 316). In some examples, the shader compiler 308 may pre-compile the shaders 324-326 and store the object code or intermediate code of the shader programs in the system memory 124. The shader compiler 308 (or in another example the GPU driver 310) executing on the CPU 302 may build a shader program with multiple components including the early preamble shader 324, the feedback shader 325, and the main shader 326. The main shader 326 may correspond to a portion or the entirety of the shader program that does not include the early preamble shader 324 or the feedback shader 325. The shader compiler 308 may receive instructions to compile the shader(s) 324-326 from a program executing on the CPU 302. The shader compiler 308 may also identify constant load instructions and common operations in the shader program for including the common operations within the early preamble shader 324 (rather than the main shader 326). The shader compiler 308 may identify such common instructions, for example, based on (presently undetermined) constants 306 to be included in the common instructions. The constants 306 may be defined within the graphics API 304 to be constant across an entire draw call. The shader compiler 308 may utilize instructions such as a preamble shader start to indicate a beginning of the early preamble shader 324 and a preamble shader end to indicate an end of the early preamble shader 324. Similar instructions may be used for the feedback shader 325 and the main shader 326. The feedback shader 325 will be described in further detail below.

The shader core 316 included in the GPU 312 may include general purpose registers (GPRs) 318 and constant memory 320. The GPRs 318 may correspond to a single GPR, a GPR file, and/or a GPR bank. Each GPR in the GPRs 318 may store data accessible to a single thread. The software and/or firmware executing on GPU 312 may be a shader program 324-326, which may execute on the shader core 316 of GPU 312. The shader core 316 may be configured to execute many instances of the same instructions of the same shader program in parallel. For example, the shader core 316 may execute the main shader 326 for each pixel that defines a given shape. The shader core 316 may transmit and receive data from applications executing on the CPU 302. In examples, constants 306 used for execution of the shaders 324-326 may be stored in a constant memory 320 (e.g., a read/write constant RAM) or the GPRs 318. The shader core 316 may load the constants 306 into the constant memory 320. In further examples, execution of the early preamble shader 324 or the feedback shader 325 may cause a constant value or a set of constant values to be stored in on-chip memory such as the constant memory 320 (e.g., constant RAM), the GPU memory 322, or the system memory 124. The constant memory 320 may include memory accessible by all aspects of the shader core 316 rather than just a particular portion reserved for a particular thread such as values held in the GPRs 318.

GPUs can render images in a variety of different ways. In some instances, GPUs can render an image using rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects, during a binning pass, an image can be divided into different bins or tiles. In some aspects, during the binning pass, a visibility stream can be constructed where visible primitives or draw calls can be identified. In contrast to tiled rendering, direct rendering does not divide the frame into smaller bins or tiles. Rather, in direct rendering, the entire frame is rendered at a single time. Additionally, some types of GPUs can allow for both tiled rendering and direct rendering.

In some aspects, GPUs can apply the drawing or rendering process to different bins or tiles. For instance, a GPU can render to one bin, and perform all the draws for the primitives or pixels in the bin. During the process of rendering to a bin, the render targets can be located in the GMEM. In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a visibility or bin- visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory used to drop primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

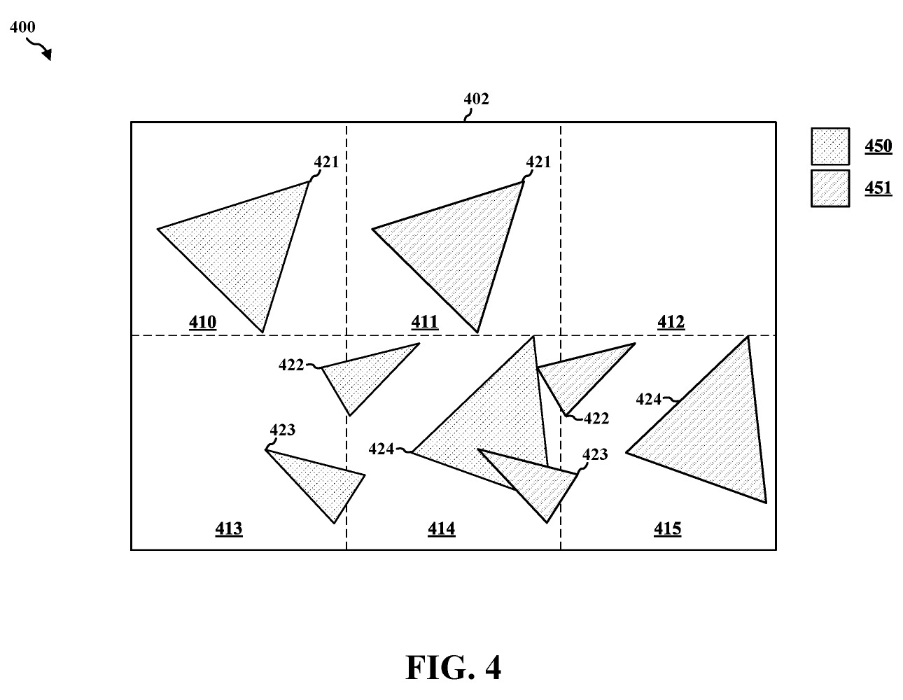

FIG. 4 illustrates image or surface 400, including multiple primitives divided into multiple bins. As shown in FIG. 4, image or surface 400 includes area 402, which includes primitives 421, 422, 423, and 424. The primitives 421, 422, 423, and 424 are divided or placed into different bins, e.g., bins 410, 411, 412, 413, 414, and 415. FIG. 4 illustrates an example of tiled rendering using multiple viewpoints for the primitives 421-424. For instance, primitives 421-424 are in first viewpoint 450 and second viewpoint 451. As such, the GPU processing or rendering the image or surface 400 including area 402 can utilize multiple viewpoints or multi-view rendering.

As indicated herein, GPUs or graphics processor units can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

In some aspects of graphics processing, GPU hardware may be divided into multiple sections, e.g., hardware for geometry processing and hardware for pixel processing. Scalable GPU hardware may be desirable in order to meet different throughputs across various market segments. Also, in some aspects, scalable hardware for pixel processing may be designed in a variety of ways. For instance, a screen may be divided into different parts and multiple pixel processing hardware modules (i.e., slices) may work independently on different parts of the screen. By changing the number of pixel slices, a scalable throughput may be achieved for different tiers. However, designing scalable geometry processing hardware has an inherent challenge of evenly distributing the workload across independently working hardware modules (i.e., geometry slices).

There are a number of issues that may be encountered when designing scalable geometry processing hardware. For instance, the variable size of a drawcall (i.e., a work unit) and an adaptive workload expansion in the middle of the geometry pipeline are some issues that may occur when designing scalable geometry processing hardware. Workloads across different draw calls may vary, so tying each drawcall to a geometry slice may create uneven data downstream. Apart from this, an application program interface (API) may specify that a geometry pipeline may support adaptive workload expansion/reduction through different features, e.g., tessellation, geometry shading, and/or triangle culling.

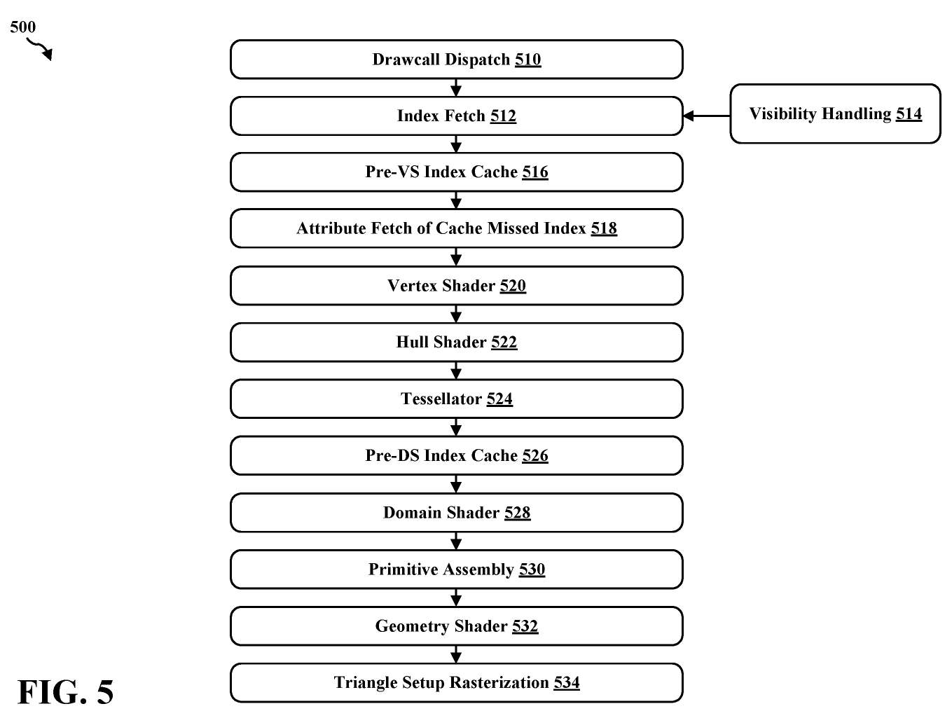

FIG. 5 is a diagram 500 illustrating an example geometry pipeline in a GPU. As depicted in FIG. 5, diagram 500 includes a drawcall dispatch 510, an index fetch 512, a visibility handling step 514, a pre-vertex shader index cache 516, an attribute fetch of a cache missed index 518, a vertex shader 520, a hull shader 522, a tessellator 524, a pre-domain shader index cache 526, a domain shader 528, a primitive assembly 530, a geometry shader 532, and a triangle setup rasterization 534. As shown in FIG. 5, after an index fetch 512, each primitive may be expanded to create multiple primitives, where an amplification factor may be determined during run-time. As such, sending primitives to different modules without considering an amplification factor may create an unequal workload in a downstream pipeline. Accordingly, this may prevent the achievement of an optimal throughput.

Another issue that may be encountered when designing scalable geometry processing hardware is visibility handling (e.g., tiled rendering) across multiple geometry slices. As indicated above, in tile-based rendering, the screen is divided into multiple bins, and a binning pass is used to generate a per-bin visibility stream (i.e., primitives that may be identified as visible in a bin). Also, the visibility stream may be used in multiple bin-rendering passes (e.g., dropping invisible primitives from processing) to render the whole screen. Because of different visibilities of primitives, the workload pattern in each bin-rendering pass may vary significantly from a binning pass. A workload distribution scheme may need to ensure that an even workload (including amplification) is distributed to each geometry slice (even when accounting for the potential disparity in visibility).

In some aspects, different types of GPU hardware may support different types of workload execution. Additionally, different types of workloads may take a different amount of processing time in various stages of the GPU pipeline. Also, these types of workloads may introduce inefficiency in GPU hardware utilization. In some aspects, scheduling algorithms in order to time-share the GPU hardware may sequence the workload to achieve the best utilization of GPU hardware. This kind of workload pattern is common in certain types of binning (e.g., concurrent binning). For example, in concurrent binning, a tile sorting pass for a certain frame (e.g., frame 'N+1') may be run concurrently with a rendering pass of another frame (e.g., frame 'N').

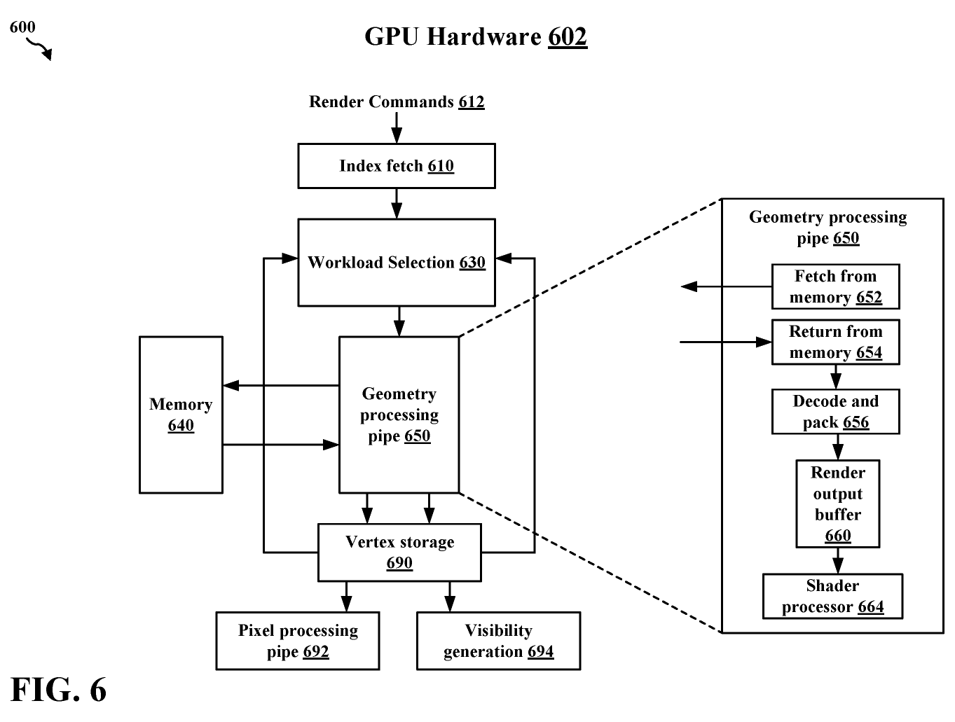

FIG. 6 illustrates diagram 600 including one example of GPU hardware. More specifically, diagram 600 depicts a time-shared GPU hardware for concurrent binning. As shown in FIG. 6, diagram 600 includes GPU hardware 602 including index fetch component 610, workload selection component 630, memory 640, geometry processing pipe 650, vertex storage component 690, pixel processing pipe 692, and visibility generation component 694. As shown in FIG. 6, render commands 612 may be input to index fetch component 610, which may be output to workload selection component 630. The workload selection component 630 may have a render/sort selection capability, as well as a certain granularity (e.g., a granularity for a group of N primitives). Also, the workload selection component 630 may be referred to as a workload selection switch component, switch component, workload selection component, or selection component. The "switch" may refers to a switch in the selection of render/sorting workloads. The output of workload selection component 630 may be sent to geometry processing pipe 650, which may communicate with memory 640. The geometry processing pipe 650 may include fetch from memory component 652, return from memory component 654, decode and pack component 656, render output buffer 660, and shader processor 664. Also, the output of geometry processing pipe 650 may be sent to vertex storage component 690, which may be sent to pixel processing pipe 692 and visibility generation component 694.

As shown in FIG. 6, geometry pipe hardware (e.g., geometry processing pipe 650) may be time shared between tile sorting and tile render workloads. Also, a scheduling algorithm (e.g., workload selection component 630) may consider the availability of GPU hardware for tile sorting and tile render workload. The granularity of a workload may be selected such that there is limited workload switching overhead. Further, the granularity of a workload may be selected such that, at the same time, one workload does not block the other. As shown in FIG. 6, the workload selection component 630 may have a granularity of a group of N primitives. For instance, for concurrent binning, the workload distribution granularity may be a primitive batch (e.g., a set of N primitives).

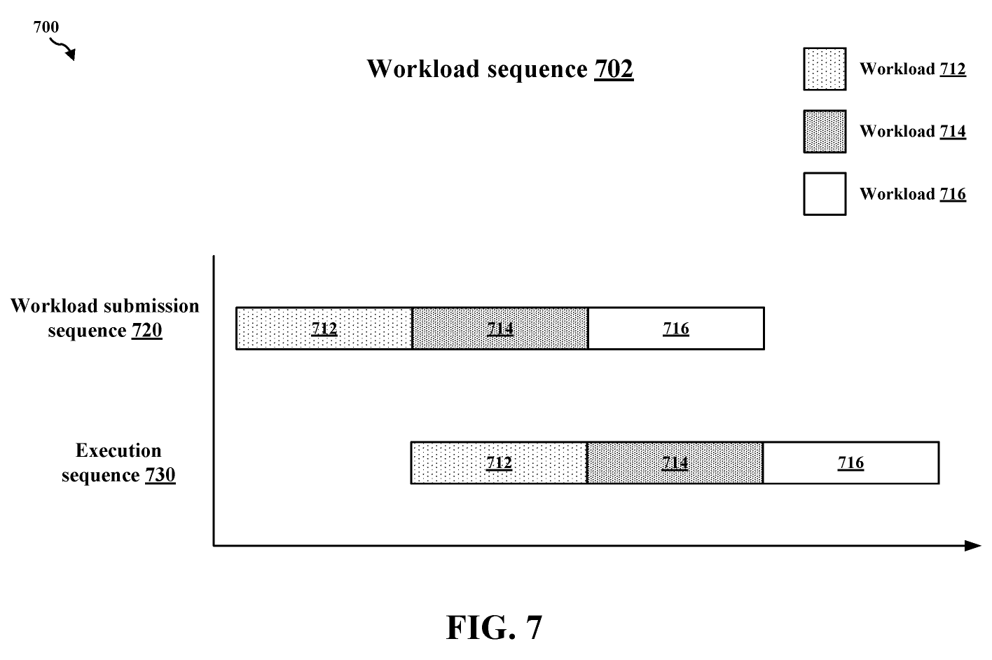

Certain types of workloads (e.g., sorting workloads) may face higher memory access latencies compared to other types of workloads (e.g., render workloads). For example, render workloads may be of higher priority than sorting workloads, which may face higher memory access latencies. In some aspects, if these types of workloads (e.g., sorting workloads) are executed in-order as per the scheduled workload sequence and granularity, there may be a reduction in hardware efficiency. For instance, if these types of workloads (e.g., sorting workloads) are executed in- order as per the scheduled workload sequence and granularity, a certain workload block (e.g., a head-of-line block) may occur, thus reducing the hardware efficiency. This type of scenario is shown in FIG. 7.

FIG. 7 illustrates diagram 700 including one example of a workload execution sequence. More specifically, diagram 700 depicts a workload execution sequence for a GPU (i.e., a scheduled execution order). As shown in FIG. 7, diagram 700 includes workload sequence 702 including workload 712, workload 714, workload 716, workload submission sequence 720, and execution sequence 730. FIG. 7 depicts a timeline of workload execution including workload submission sequence 720 and execution sequence 730. FIG. 7 illustrates that certain types of workloads (e.g., workload 712, workload 714, and workload 716) are executed in a certain order as per the scheduled workload sequence. As shown in FIG. 7, consider a workload submission sequence 720 (e.g., as determined by the workload selection component 630 in FIG. 6) to be workload 712, workload 714, and workload 716. Each of these workload may need to fetch data from memory (e.g., memory 640) and send it to shader processor (e.g., shader processor 664) for further processing. In some aspects, there may be a limit on how many requests can be made without processing the returned data (e.g., an OT limit). In some instances, some of the memory accesses for workload 714 may be granted before all accesses for workload 712, and some of the memory accesses for workload 716 may be granted before all accesses for workload 714.

In aspects of graphics processing, some graphics applications may render to a single target, i.e., a render target, one or more times. For instance, in graphics rendering, a frame buffer on a system memory may be updated multiple times. The frame buffer may be a portion of memory or random access memory (RAM) (e.g., containing a bitmap or storage) to help store display data for a GPU. The frame buffer may also be a memory buffer containing a complete frame of data. Additionally, the frame buffer may be a logic buffer. In some aspects, updating the frame buffer may be performed in bin or tile rendering, where, as discussed above, a surface is divided into multiple bins or tiles and then each bin or tile may be separately rendered. Further, in tiled rendering, the frame buffer may be partitioned into multiple bins or tiles.

As indicated herein, graphics processors (e.g., GPUs) may work in a number of different fashions (e.g., a single instruction, multiple data (SIMD) fashion). GPUs may process certain types of instructions that are associated with an operation (e.g., an SIMD operation). For instance, a GPU may process wave instructions or waves, which are the width of data elements that are operated on by a single instruction associated with the SIMD. The term wave may also refer to a set of threads or blocks that run concurrently on the GPU. Waves may be allocated into sub-waves, which may include a number of threads or fibers. An active thread/fiber may refer to a thread/fiber that executes instructions (e.g., instructions in the ALU). An inactive thread/fiber may refer to a thread/fiber that does not execute instructions. Threads/fibers that do not partake in a branching operation may eventually become inactive (i.e., partake in the next level of the hierarchy). A kernel may be a programming operations manager or a programming thread at a GPU. Also, a kernel may be executed in parallel by an array of threads/fibers, where all threads/fibers may run the same code. Each thread/fiber may have an identifier (ID) that it uses to compute memory addresses and make control decisions. GPUs may also process a number of different operations, such as an atomic operation. An atomic operation may enable another operation (e.g., a read-modify-write operation or a read-write operation) to occur without any interruption. As such, an atomic operation may assure that no other execution operation at a GPU may have been inserted between the target operation (e.g., a read-modify-write operation or a read-write operation).

In some aspects, a shader in the context of a graphics processor (e.g., a GPU) may be a program that is used to control the rendering effects of three-dimensional (3D) computer graphics. There are different types of shaders (e.g., vertex shaders, pixel shaders, and geometry shaders), each of which may handle a different aspect of the rendering process. Shaders may be used to produce realistic lighting, shadows, textures, and other visual effects in video games, simulations, and other 3D applications. A shader processor may utilize one or more context states to perform various operations and calculations. For instance, a shader processor may be part of multiple shared cores for integer processing. Also, a shader processor may execute shader code (e.g., vertex shaders, fragment shaders, compute shaders, etc.). The shader processor may also be referred to as a shader core. Shader code may also be referred to as a shader and may refer to a user-defined program configured to run in a stage of the GPU. In an example, the shader code may be associated with the rendering of graphical content. The shader processor may include a number of different components, such as arithmetic logic units (ALUs) and general purpose registers (GPRs). An ALU may be a combinatorial digital circuit that performs arithmetic and bitwise operations on integer binary numbers (e.g., a signed integer, an unsigned integer, etc.). A GPR may be a register that stores both data and addresses, that is, the GPR may be a combined data/address register. A register may refer to a location that may be accessed by a processor. A register may include a small amount of relatively quickly accessible storage.

As indicated herein, a kernel may be a programming operations manager or a programming thread at a GPU. Also, a kernel may be executed in parallel by an array of threads, where all threads may run the same code. Each thread may have an identifier (ID) that it uses to compute memory addresses and make control decisions. A warp may be a collection of threads (e.g., 32 threads) that are executed simultaneously by a symmetric multiprocessor (SM). A warp may be a basic unit of execution, where multiple warps may be executed on an SM at once. When a program on a CPU invokes a kernel grid, the blocks of the grid may be enumerated and distributed to SMs with available execution capacity. The threads of a thread block may execute concurrently on one SM, and multiple thread blocks may execute concurrently on one SM. As thread blocks terminate, new blocks are launched on the vacated SMs. The mapping between warps and thread blocks may affect the performance of the kernel. Also, a clock or GPU clock may be a logical beat or time that is used to synchronize actions of the GPU. A clock source may manage how a GPU component derives its clock.

A symmetric multiprocessor (SM) may be single instruction multiple thread processor which has multiple shared cores at a GPU (e.g., shader processors) for integer processing, special functional units (SFUs) (e.g., for calculating functions such as sine, cosine, root mean-squared (RMS), etc.). The SM may have load store (LD/ST) units for load and store into memory/registers. The SM may also have L1 caches, shared caches and large-banked register files. A concurrent thread array (CTA) may be a basic workload unit assigned to an SM in a GPU. Threads in a CTA may be sub- grouped into a warp/wavefronts, which is the smallest execution unit sharing the same program counter. A last level cache (LLC) may be a last level of cache from a GPUs context, such as an extended cache for SMs. An interconnect unit may be a crossbar switch which does multi-master arbitration, by which GPUs are connected to rest of the world. Further, a pointer of serialization / pointer of coherence (PoS/PoC) may be point in the system-on-chip (SoC) post where every master in the system may see the same coherent copy of data.

Some aspects of graphics processing may utilize certain GPU architectures and/or application structures. For instance, aspects of graphics processing may utilize a general purpose GPU (GPGPU) architecture that includes symmetric multiprocessor (SMs), shared cores, an interconnect unit, a dynamic random access memory (DRAM), and/or a number of different caches (e.g., a first level (L1) cache, a second level (L2) cache, and/or a last level cache (LLC)). In some instances of GPU architectures, a number of SMs, shared cores, and L1 caches may be connected to an interconnect unit. The interconnect unit may be connected to L2 caches and DRAMs. Additionally, in an application structure, an application may include a number of kernels, and each of the kernels may include concurrent thread arrays (CTAs), where each CTA includes a number of warps.

Some types of GPUs may include a number of different types of registers or memory, such as general purpose registers (GPRs). A GPR may be a register that stores both data and addresses. That is, the GPR may be a combined data/address register. A register may refer to a location that may be accessed by a processor. Additionally, a register may include a small amount of relatively quickly accessible storage. GPUs may include other types of memory, such as graphics memory (GMEM) or on-chip memory, which may store data or data buffers.

Modern GPUs may include a number of different types of GPRs, such as vector GPRs and scalar GPRs. Vector GPRs are fiber based GPRs, which are costly to GPU performance and memory (e.g., each fiber may have its own GPR). As indicated above, the term wave may refer to a set of threads or blocks that run concurrently on a GPU, where waves may include a number of fibers for executing instructions at the GPU. Vector GPRs may also limit a parallel wave number at a GPU. Scalar GPRs may be shared by all fibers in a wave, which may be cheaper to build/access, as well as more power efficient, than vector GPRs. For example, in a vector GPR, 1 wave of 64 fibers may correspond to 64 physical instances of the vector GPR using the GPU hardware. In a scalar GPR, there may be one GPR inside of the GPU hardware. That is, a GPU may include scalar GPRs and vector GPRs, where scalar GPRs may be more efficient than vector GPRs.

In graphics processing and computer graphics, a shader may be a computer program that calculates a level of light (e.g., light, darkness, and color) during the rendering of a scene. This process of rendering and shading a scene may be referred to as shading. Shaders may perform a variety of specialized functions in graphics processing, computer graphics, video post-processing, and general-purpose computing on graphics processors. A shader may be a program that is used to control the rendering effects of computer graphics. There may be a number of different types of shaders (e.g., vertex shaders, pixel shaders, and geometry shaders), which may handle a different aspect of the rendering process. Shaders may be used to produce lighting, shadows, textures, and other visual effects in video games, simulations, and other applications. A shader processor may utilize context states to perform various operations and calculations. That is, a shader processor may be part of multiple shared cores for integer processing. Additionally, a shader processor may execute shader code (e.g., vertex shaders, fragment shaders, compute shaders, etc.).

In computer graphics, primitives may be rendered from coordinates (e.g., 3D coordinates) to a screen by processing the primitives via a sequence of stages. The sequence of stages may be referred to as a graphics pipeline (e.g., a graphics pipeline in a GPU). Different hardware vendors may provide a graphics processing unit (GPU) to render the primitives by aligning with the graphics pipeline. The pipeline may be composed of fixed function stages and programmable stages. Also, the pipeline may be programmed by application provided programs called shaders. Also, shader instructions may executed by the GPU component a shader processor (SP). Shader processors may be referred to as the powerhouse of the GPU, as they are an entirely arithmetic logic unit (ALU) heavy component. Further, shader processors bring parallelism into the GPU.

One type of rendering approach is tile rendering (e.g., for low power GPUs). Tiled rendering (or binned rendering) is the process of subdividing a computer graphics scene by a rectangular grid in display space and separately rendering each section of the grid (i.e., called bin or tile). Tiled rendering may be utilized by GPUs which have limited memory access bandwidth. Tiled rendering is performed in two passes to maximize the GPU utilization, that is, a binning pass and a rendering pass. The binning pass may analyze the frame and determine the primitives belonging to each bin. This resultant map of primitives to bin may be stored in some intermediate data structure. The rendering pass may render each bin separately. For each bin, this intermediate map may be queried, and just the primitives which belong to the respective bin may be rendered to an on-chip buffer. At the end of the render pass of each bin, the on-chip buffer may be resolved to the system memory and/or display buffer.

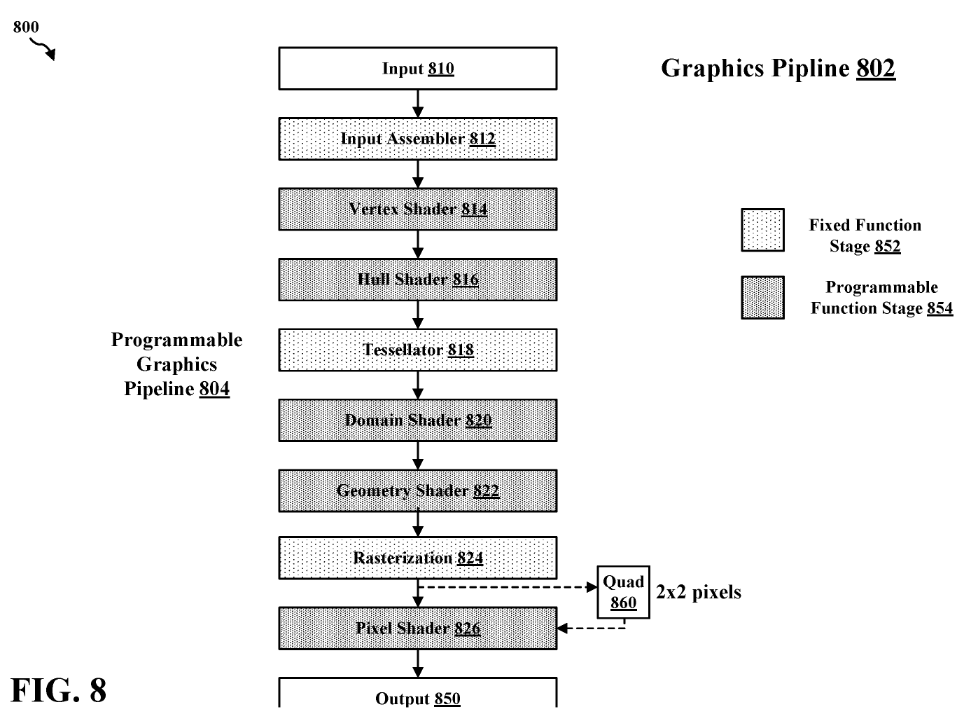

Some types of graphics workloads (e.g., DirectX (DX) workloads) and workloads generated by the advanced rendering techniques may have a significant number of primitives that are less than a certain threshold size (e.g., small triangles). When small triangles are rendered using a traditional graphics pipeline (as in FIG. 8), this may result in a lower utilization of fixed function hardware resources and lower ALU utilization of shader processors. This lower utilization of fixed function hardware resources may be due to the overwhelming culling rate of small triangles. Since hardware may spend a lot of cycles in culling the triangles, the rasterization throughput may be reduced, which may result into the lower utilization of the entire hardware. Also, lower ALU utilization shader processors may be because of the insignificant visible load in a draw with respect to the ALU capabilities. This may result in the degraded performance of the entire GPU in small triangles heavy workloads. That is, hardware performance may drop while rendering workloads that have significant small triangle. Advanced rendering techniques may be overloaded with small triangles. This causes of which may be: lower utilization of fixed function hardware resources, and a lower ALU utilization of shader processors.

In some aspects of computer graphics, primitives may be rendered from three- dimensional (3D) coordinates to a screen. For example, primitives may be rendered from 3D coordinates to a screen by processing the primitive via a sequence of stages, which may be referred to as a graphics pipeline. Some hardware vendors may implement a graphics pipeline in a GPU to render primitives. That is, different hardware vendors may provide a graphics processing unit (GPU) to render primitives by aligning the primitives to the graphics pipeline. The graphics pipeline may contain fixed function stages and programmable stages. Also, the graphics pipeline may be programmed by application-provided programs, which may be referred to as shaders. There are multiple types of shaders (as shown in FIG. 8), such as a vertex shader (VS), a hull shader (HS), and domain shader (DS), and geometry shader (GS), and a pixel shader (PS). The pixel shader may be used to shade pixels.

FIG. 8 illustrates diagram 800 including one example of a graphics pipeline. More specifically, diagram 800 depicts graphics pipeline 802, which is an example of a programmable graphics pipeline. As shown in FIG. 8, diagram 800 includes graphics pipeline 802 including programmable graphics pipeline 804, as well as input 810 and output 850. As depicted in FIG. 8, programmable graphics pipeline 804 includes input assembler 812, vertex shader 814, hull shader 816, tessellator 818, domain shader 820, geometry shader 822, rasterization component 824, and pixel shader 826. Each of the stages shown in FIG. 8 are a fixed function stage 852 or a programmable function stage 854. For instance, input assembler 812, tessellator 818, and rasterization component 824 are a fixed function stage 852. Also, vertex shader 814, hull shader 816, domain shader 820, geometry shader 822, and pixel shader 826 are a programmable function stage 854. Further, as shown in quad 860 in FIG. 8, a GPU may schedule pixels in the form of quadrants (quads) after rasterization component 824 for pixel shader 826. Quad 860 may be a quadrant of pixels (e.g., a 2x2 block of pixels) or a block of pixels including any appropriate amount of pixels.

In some aspects, shader instructions may be executed by a GPU component, such as a shader processor (SP). More specifically, shader instructions may be executed in single instruction multiple data (SIMD) fashion in a GPU component called a shader processor (SP). Shader processors may be an arithmetic logic unit (ALU)-heavy component and provide the parallelism to the GPU. Accordingly, the shader processor may be referred to as the powerhouse of the GPU. There may be many SPs within the GPU, and each SP may be composed of multiple ALUs. Also, each SP may be able to launch multiple threads called fibers. For instance, one thread (also referred to as a fiber) may execute the pixel shader for one pixel. A collection or group of fibers may be called a wave. Further, all fibers belonging to a wave may execute in single instruction multiple data (SIMD) fashion.

Additionally, each fiber may shade one pixel during pixel shader execution. Pixel shader instructions may be executed within the wave in SIMD fashion, where each fiber may belong to a respective wave that executes instructions for each pixel. Moreover, a GPU may schedule pixels in the form of quadrants (quads) after rasterization for pixel shading (see quad 860 in FIG. 8). In some instances, one fiber of a shader processor may be assigned to one pixel of the quad. Further, a wave may contain multiple quads. Also, quads can be partially covered (i.e., not all 4 pixels of a quad contain a valid pixel for pixel shading). When a quad is partially covered, this may decrease the ALU utilization because a shader processor may assign a dummy fiber for an uncovered pixel.

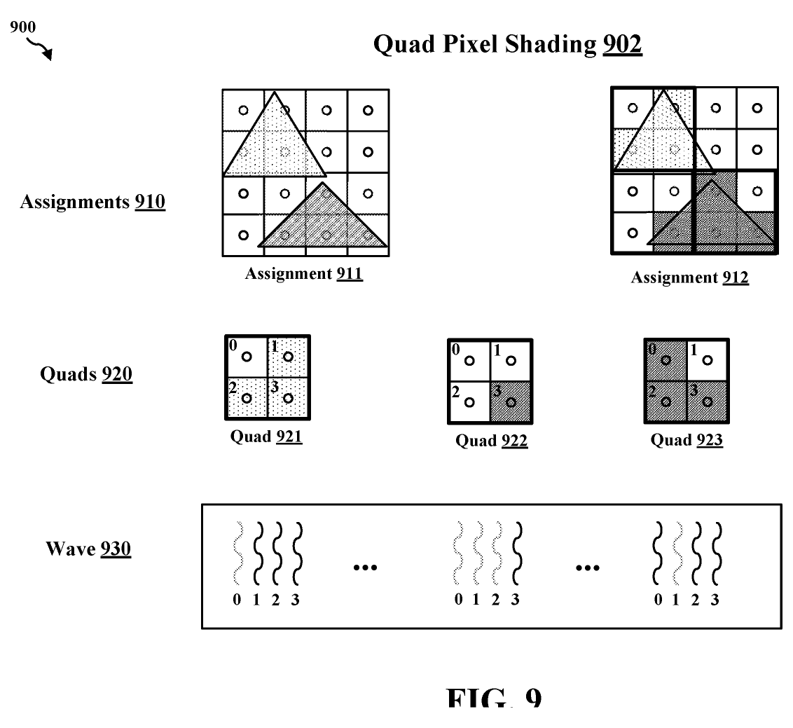

FIG. 9 illustrates diagram 900 including one example of a quadrant (quad) pixel shading process. More specifically, diagram 900 depicts quad pixel shading 902 including an assignment process, a number of quads, and waves. As shown in FIG. 9, diagram 900 includes assignments 910 including assignment 911 and assignment 912, quads 920 including quad 921, quad 922, and quad 923, and wave 930. As depicted in FIG. 9, assignment 911 includes two triangles that cover or partially cover pixels. For instance, the triangle in the upper left of assignment 911 covers 3 pixels in the upper left quad, which is further shown by the 3 lightly dotted pixel areas in assignment 912. Quad 921 shows this 2x2 quad of pixels, where 3 of the 4 pixels are covered with lightly dotted pixel areas. The triangle in the bottom right of assignment 911 covers 4 pixels in the bottom right area spread out over 2 quads. This is further shown by the 4 darkly dotted pixel areas in assignment 912. Quad 922 shows one 2x2 quad of pixels, where 1 of the 4 pixels is covered with a darkly dotted pixel area. Quad 923 shows another 2x2 quad of pixels, where 3 of the 4 pixels are covered with darkly dotted pixel areas. Wave 930 shows the waves (i.e., a collection or group of fibers) that correspond to quad 921, quad 922, and quad 923.

As shown in FIG. 9, triangles are creating uncovered portions of quads (e.g., quad 921, quad 922, and quad 923). Also, as shown in FIG. 9, pixels are assigned to different fibers in the wave (e.g., wave 930). The shader processor (SP) may assign dummy fibers to uncovered pixels of quad, which may form a hole. That is, a hole may refer to an uncovered pixel of quad that is assigned dummy fibers. The light gray fibers in wave 930 of FIG. 9 demonstrate dummy fibers that may form a hole. These dummy fibers may decrease the ALU utilization, as they are consuming SP resources for an invalid pixel. As these dummy fibers may create holes, it is the holes that decrease the ALU utilization in the SP.

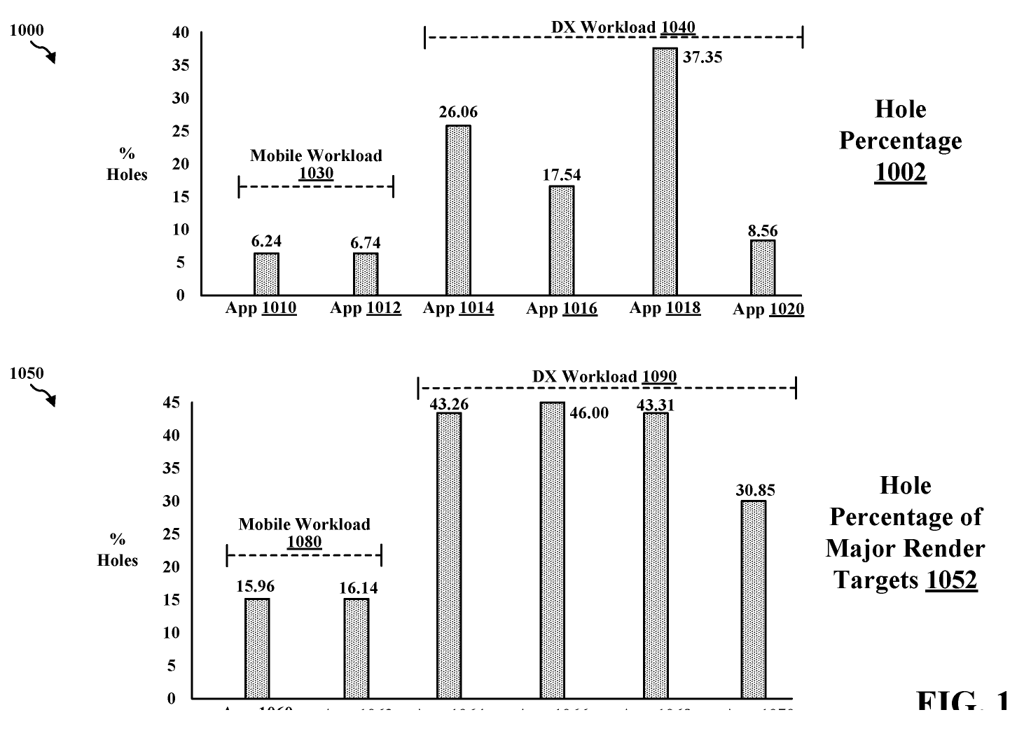

FIG. 10 illustrates graph 1000 and graph 1050 including examples of hole percentage. More specifically, graph 1000 depicts an example hole percentage 1002 that charts the percentage of holes for a number of applications. As shown in FIG. 10, graph 1000 includes application 1010, application 1012, application 1014, application 1016, application 1018, and application 1020. As depicted in FIG. 10, application 1010 includes a hole percentage of 6.24%, application 1012 includes a hole percentage of 6.74%, application 1014 includes a hole percentage of 26.06%, application 1016 includes a hole percentage of 17.54%, application 1018 includes a hole percentage of 37.35%, and application 1020 includes a hole percentage of 8.56%. Application 1010 and application 1012 are included in mobile workload 1030. Further, application 1014, application 1016, application 1018, and application 1020 are included in Direct X (DX) workload 1040 (e.g., an application program interface (API) workload). As shown in FIG. 10, the amount of holes may reduce the ALU utilization. Accordingly, an increase in hole percentage may decrease the ALU utilization.

As shown in FIG. 10, graph 1050 depicts an example hole percentage of major render targets 1052 that charts the percentage of holes of major render targets for a number of applications. Graph 1050 includes application 1060, application 1062, application 1064, application 1066, application 1068, and application 1070. As depicted in FIG. 10, application 1060 includes a hole percentage of 15.96%, application 1062 includes a hole percentage of 16.14%, application 1064 includes a hole percentage of 46.26%, application 1066 includes a hole percentage of 46.00%, application 1068 includes a hole percentage of 43.31%, and application 1070 includes a hole percentage of 30.85%. Application 1060 and application 1062 are included in mobile workload 1080. Moreover, application 1064, application 1066, application 1068, and application 1070 are included in Direct X (DX) workload 1090 (e.g., an application program interface (API) workload).

As shown in FIG. 10, the amount of holes in major render targets may reduce the ALU utilization. Accordingly, an increase in hole percentage in major render targets may decrease the ALU utilization. As further shown in FIG. 10, ALU utilization may decrease more for small triangle-heavy workloads (e.g., workloads with a large amount of triangles or primitives that are less than a threshold size), such as a DirectX (DX) workload (e.g., an application program interface (API) workload) and advanced rendering techniques (e.g., Gaussian splatting, etc.). Indeed, as shown in FIG. 10, the issue of a decrease in ALU utilization may be aggravated significantly for small triangle-heavy workloads (e.g., DX workloads or API workloads). Based on the above, it may be beneficial to increase the ALU utilization at a GPU. Further, it may be beneficial to reduce the number of holes that are processed by a shader processor. That is, it may be beneficial to decrease the number of workloads that include holes that are processed by a shader processor in order to increase the ALU utilization.

Aspects of the present disclosure may increase the ALU utilization at a GPU. Also, aspects presented herein may reduce the number of holes that are processed by a shader processor. That is, aspects presented herein may decrease the number of workloads that include holes that are processed by a shader processor. By doing so, aspects presented herein may increase the ALU utilization at a shader processor. In order to decrease the number of workloads that include holes, aspects presented herein may compress quads that belong to a same location. For example, aspects herein may compress quads that belong to a same location before scheduling the quads for pixel shading. That is, aspects herein may compress quads that correspond to a same pixel or group of pixels before scheduling the quads for pixel shading. For instance, aspects herein may compress at least two quads together that correspond to a same set of pixels before scheduling the quads for pixel shading. By doing so, aspects presented herein may decrease the number of workloads that include holes that are processed by a shader processor, which increases the ALU utilization at a shader processor. In turn, this may optimize or improve the overall performance of a GPU.

Aspects presented herein (e.g., a GPU) may obtain an indication of a set of quadrants for at least one draw call in a set of draw calls associated with a frame, where each of the set of quadrants includes a plurality of pixels in the frame. Aspects presented herein (e.g., a GPU) may also determine whether each of a set of conditions associated with the set of quadrants is met, where a compression of at least two quadrants or a refrainment from compression of the at least two quadrants is based on the determination. Aspects presented herein (e.g., a GPU) may also determine whether to compress the at least two quadrants in the set of quadrants based on each of the set of conditions associated with the set of quadrants being met. The set of conditions may include at least one of: an upcoming quadrant in the set of quadrants belongs to a same position as an existing quadrant in the set of quadrants, a coverage for the upcoming quadrant is not overlapped by the existing quadrant, a coverage for the set of quadrants is unfilled after the compression, the upcoming quadrant is not fully covered, a draw associated with the at least one draw call has not ended, the at least one draw call has not ended, or a compression limit for the set of quadrants is not achieved. Additionally, aspects presented herein (e.g., a GPU) may compress at least two quadrants in the set of quadrants based on a set of conditions associated with the set of quadrants, or refrain from compressing the at least two quadrants in the set of quadrants based on the set of conditions associated with the set of quadrants. Aspects presented herein (e.g., a GPU) may also adjust a capacity of at least one memory based on the compression of the at least two quadrants or the refrainment from the compression of the at least two quadrants. Moreover, aspects presented herein (e.g., a GPU) may configure a compression buffer based on the compression of the at least two quadrants or the refrainment from the compression of the at least two quadrants. Aspects presented herein (e.g., a GPU) may also store, in the compression buffer, data for the at least two quadrants based on the compression of the at least two quadrants or the refrainment from the compression of the at least two quadrants. Aspects presented herein (e.g., a GPU) may also output an indication of the compression of the at least two quadrants or the refrainment from the compression of the at least two quadrants.

In some aspects, aspects presented herein (e.g., a GPU) may compress quadrants if an upcoming quadrant in the set of quadrants belongs to a same position as an existing quadrant in the set of quadrants. Also, aspects presented herein (e.g., a GPU) may compress quadrants if a coverage for the upcoming quadrant is not overlapped by the existing quadrant. So that means the overlapping quads do not occur. Further, aspects presented herein (e.g., a GPU) may compress quadrants if a coverage for the set of quadrants is unfilled after the compression or the upcoming quadrant is not fully covered. For example, in this scenario, the compression is not performed because the quad coverage is not full after the compression. So aspects presented herein may not perform the compression since it will overlap the pixel. Moreover, aspects presented herein (e.g., a GPU) may compress quadrants if a draw associated with the at least one draw call has not ended, or the at least one draw call has not ended. So from the application side, the application may schedule multiple draws which have to contend this algorithm within the draw itself. This particular algorithm may be there once the draw is ended, so the compression may end. Also, aspects presented herein (e.g., a GPU) may compress quadrants if a compression limit for the set of quadrants is not achieved. The compression limit may apply to the hardware blocks if there are continuous transactions.

Aspects presented herein may takes the advantage of locality at the shader processor. For instances, meshes may be structured in workloads and games, so there is a high probability of incoming multiple quads at a same location. Quads are continuously coming to a shader processor for pixel shading. Aspects presented herein may compress the incoming quads before sending the quads to the pixel shading in the shader processor. So aspects presented herein are compressing a continuous number of quads (e.g., N number of quads, where N is referred to as the compression limit). Aspects presented herein may utilize one compression buffer after rasterization and before a pixel shading stage. Since aspects presented herein are compressing the quads, more primitives may be sent for pixel shading. So aspects herein may increase the local memory (LM) of shader processors to accommodate all the primitives. That is, shader processor local memory (LM) may be increased as quad compression may send more primitives/waves.

Additionally, aspects presented herein may be compressing the continuous number of quads (e.g., N quads). Once compression breaks, it starts again from the current quad. Also, compression may break if any of the following conditions is false: an upcoming quad belongs to the same position, and upcoming quad coverage is not overlapped by existing quad, a quad coverage is not full after compression, an upcoming quad is not fully covered, a draw is not ended, and/or a compression limit (N) is not achieved, where N > 1. As indicated herein, aspects herein may utilize a compression buffer after rasterization so that there is some local storage where the compression may be performed. After this, aspects herein may go ahead with the pixel shading. The local memory may be increased for each pixel since aspects herein may allocate more threads belonging to more primitives. Aspects herein may process more data, so eventually local memory may need to be increased as well. Aspects herein may result in a decrease in holes as the compression limit is increased. So aspects herein have resulted in a significant reduction in the number of holes for the quad compression process.

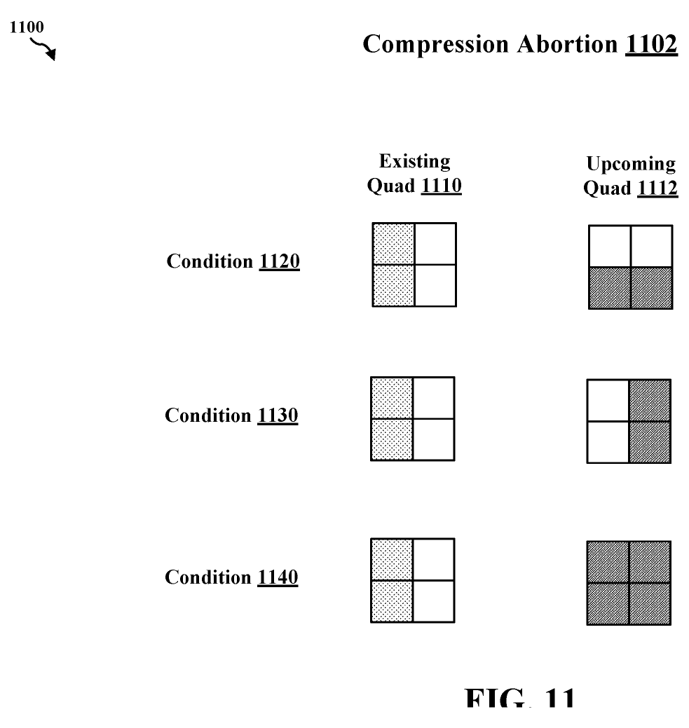

FIG. 11 illustrates diagram 1100 including one example of a compression abortion process. More specifically, diagram 1100 depicts compression abortion 1102 including an existing quad and an upcoming quad. As shown in FIG. 11, diagram 1100 includes an existing quad 1110 and an upcoming quad 1112 and a number of conditions (e.g., condition 1120, condition 1130, and condition 1140). For condition 1120, the existing quad 1110 may have two pixels covered (i.e., lightly dotted) that are on the left side of the quad, and the upcoming quad 1112 may have two pixels covered (i.e., darkly dotted) that are on the bottom side of the quad. For condition 1130, the existing quad 1110 may have two pixels covered that are on the left side of the quad, and the upcoming quad 1112 may have two pixels covered (i.e., darkly dotted) that are on the right side of the quad. For condition 1120, the existing quad 1110 may have two pixels covered (i.e., lightly dotted) that are on the left side of the quad, and the upcoming quad 1112 may have all four pixels covered (i.e., darkly dotted).

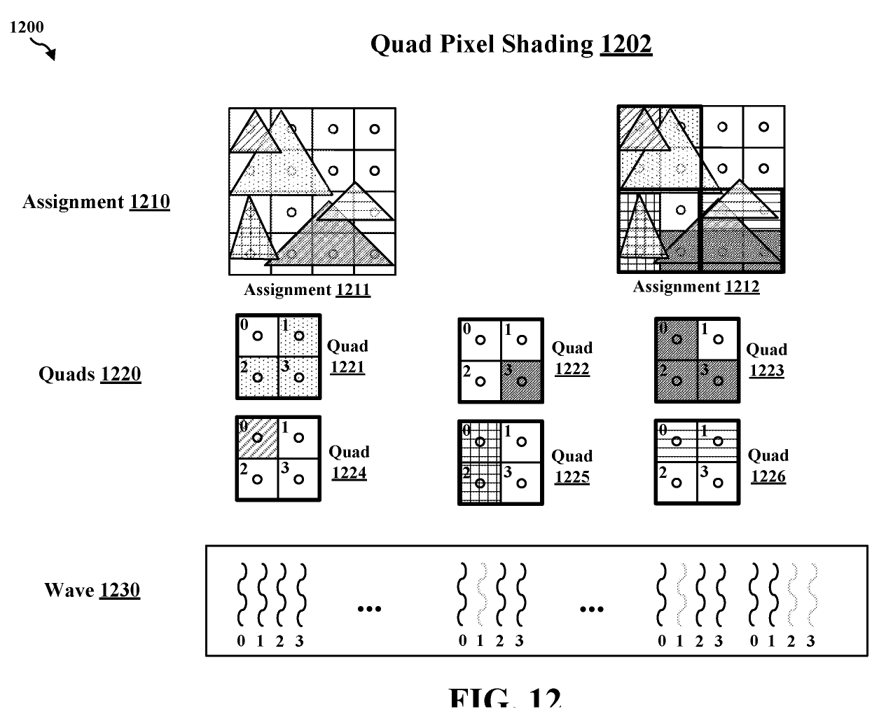

FIG. 12 illustrates diagram 1200 including one example of a quadrant (quad) pixel shading process. More specifically, diagram 1200 depicts quad pixel shading 1202 including an assignment process, a number of quads, and waves. As shown in FIG. 12, diagram 1200 includes assignments 1210 including assignment 1211 and assignment 1212, quads 1220 including quad 1221, quad 1222, quad 1223, quad 1224, quad 1225, and quad 1226, and wave 1230. As depicted in FIG. 12, assignment 1211 includes five triangles that cover or partially cover pixels. For instance, the large triangle in the upper left of assignment 1211 covers 3 pixels in the upper left quad, which is further shown by the 3 lightly dotted pixel areas in assignment 1212. Also, the small triangle in the upper left of assignment 1211 covers 1 pixels in the upper left quad, which is further shown by the 1 diagonally-lined pixel area in assignment 1212. Quad 1221 shows this 2x2 quad of pixels, where 3 of the 4 pixels are covered with lightly dotted pixel areas. Quad 1224 shows this 2x2 quad of pixels, where 1 of the 4 pixels are covered with diagonally-lined pixel areas. The triangle in the bottom right of assignment 1211 covers 4 pixels in the bottom right area spread out over 2 quads. This is further shown by the 4 darkly dotted pixel areas in assignment 1212. Quad 1222 shows one 2x2 quad of pixels, where 1 of the 4 pixels is covered with a darkly dotted pixel area. Quad 1223 shows another 2x2 quad of pixels, where 3 of the 4 pixels are covered with darkly dotted pixel areas. Also, the horizontally-lined triangle is shown in assignment 1211 as covering 2 pixels, which is further shown in assignment 1212 and quad 1226. Further, the grid-lined triangle is shown in assignment 1211 as covering 2 pixels on the bottom left, which is further shown in assignment 1212 and quad 1225. Wave 1230 shows the waves (i.e., a collection or group of fibers) that correspond to quad 1221, quad 1222, quad 1223, quad 1224, quad 1225, and quad 1226.

As shown in FIG. 12, triangles are creating uncovered portions of quads (e.g., quad 1221, quad 1222, quad 1223, quad 1224, quad 1225, and quad 1226). Also, as shown in FIG. 12, pixels are assigned to different fibers in the wave (e.g., wave 1230). The light gray fibers in wave 1230 of FIG. 12 demonstrate dummy fibers that may form a hole. As indicated above, these dummy fibers may decrease the ALU utilization by creating holes, as they are consuming SP resources for an invalid pixel. As shown in FIG. 12, aspects presented herein may reduce the number of holes. For instance, in FIG. 12, there are a reduced number of dummy fibers (i.e., light gray fibers) due to the aforementioned quad compression process. That is, FIG. 12 is a pictorial representation of quad compression, which decreases the amount of holes and improves the ALU utilization. Additionally, during the super-sampling, the shader is executed for each fragment (sample) instead of pixel, which is called fragment shading. The same technique can be used with respect to fragments in fragment shading to increase the SP ALU utilization.

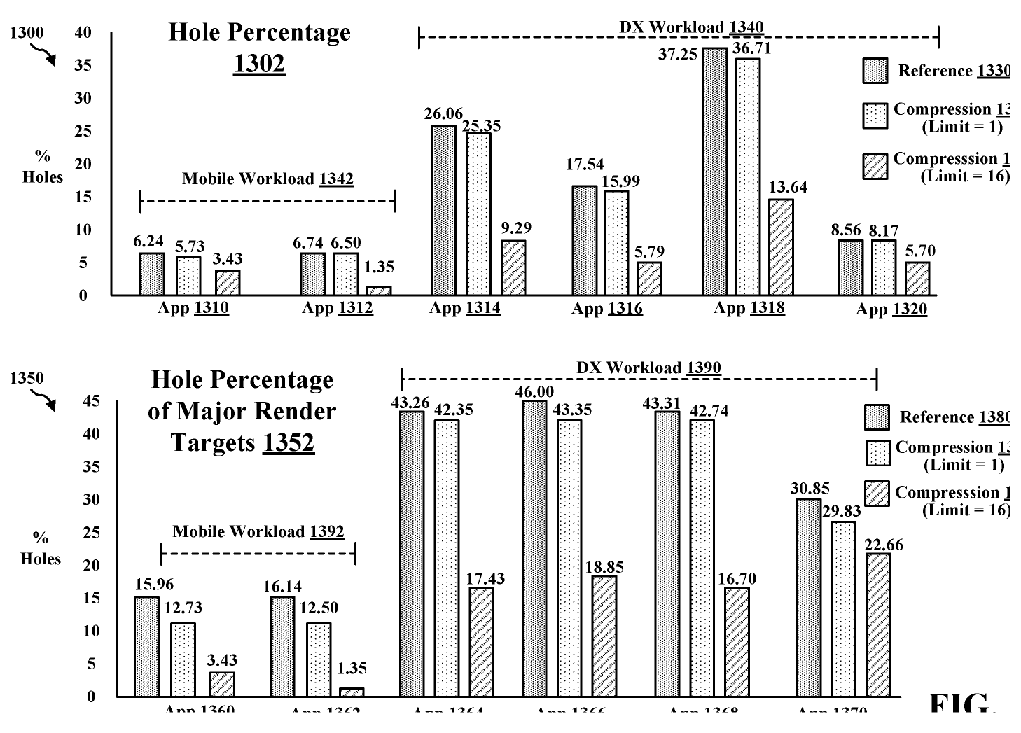

FIG. 13 illustrates graph 1300 and graph 1350 including examples of hole percentage. More specifically, graph 1300 depicts an example hole percentage 1302 that charts the percentage of holes for a number of applications. As shown in FIG. 13, graph 1300 includes application 1310, application 1312, application 1314, application 1316, application 1318, and application 1320. Application 1310 and application 1312 are included in mobile workload 1342. Further, application 1314, application 1316, application 1318, and application 1320 are included in Direct X (DX) workload 1340 (e.g., an application program interface (API) workload). Graph 1300 also depicts a hole percentage for a reference 1330, a compression 1332 (e.g., limit of 1 for quad compression), and a compression 1334 (e.g., a limit of 16 for quad compression). As depicted in FIG. 13, for reference 1330, application 1310 includes a hole percentage of 6.24%, application 1312 includes a hole percentage of 6.74%, application 1314 includes a hole percentage of 26.06%, application 1316 includes a hole percentage of 17.54%, application 1318 includes a hole percentage of 37.35%, and application 1320 includes a hole percentage of 8.56%. For compression 1332 (e.g., limit of 1 for quad compression), application 1310 includes a hole percentage of 5.73%, application 1312 includes a hole percentage of 6.50%, application 1314 includes a hole percentage of 25.35%, application 1316 includes a hole percentage of 15.99%, application 1318 includes a hole percentage of 36.71%, and application 1320 includes a hole percentage of 8.17%. For compression 1334 (e.g., limit of 16 for quad compression), application 1310 includes a hole percentage of 3.43%, application 1312 includes a hole percentage of 1.35%, application 1314 includes a hole percentage of 9.29%, application 1316 includes a hole percentage of 5.79%, application 1318 includes a hole percentage of 13.64%, and application 1320 includes a hole percentage of 5.70%.

As shown in FIG. 13, graph 1350 depicts an example hole percentage of major render targets 1352 that charts the percentage of holes of major render targets for a number of applications. Graph 1350 includes application 1360, application 1362, application 1364, application 1366, application 1368, and application 1370. Application 1360 and application 1362 are included in mobile workload 1392. Moreover, application 1364, application 1366, application 1368, and application 1370 are included in Direct X (DX) workload 1390 (e.g., an application program interface (API) workload). Graph 1350 also depicts a hole percentage for a reference 1380, a compression 1382 (e.g., limit of 1 for quad compression), and a compression 1384 (e.g., a limit of 16 for quad compression). As depicted in FIG. 13, for reference 1380, application 1360 includes a hole percentage of 15.96%, application 1362 includes a hole percentage of 16.14%, application 1364 includes a hole percentage of 46.26%, application 1366 includes a hole percentage of 46.00%, application 1368 includes a hole percentage of 43.31%, and application 1370 includes a hole percentage of 30.85%. For compression 1382 (e.g., limit of 1 for quad compression), application 1360 includes a hole percentage of 12.73%, application 1362 includes a hole percentage of 12.50%, application 1364 includes a hole percentage of 42.35%, application 1366 includes a hole percentage of 43.35%, application 1368 includes a hole percentage of 42.74%, and application 1370 includes a hole percentage of 29.83%. For compression 1384 (e.g., limit of 16 for quad compression), application 1360 includes a hole percentage of 3.43%, application 1362 includes a hole percentage of 1.35%, application 1364 includes a hole percentage of 17.43%, application 1366 includes a hole percentage of 18.85%, application 1368 includes a hole percentage of 16.70%, and application 1370 includes a hole percentage of 22.66%.

As shown in FIG. 13, graph 1300 presents the percentage of hole reduction for entire benchmarks and graph 1350 presents the percentage of hole reduction for major surfaces in benchmarks. The compression algorithm utilized herein may be analyzed by merging multiple quads with a compression limit (e.g., a compression limit = 1, 2, 4, 8, 16). Aspects herein may consider two mobile workloads (e.g., application 1360 and application 1362 in mobile workload 1392) and four DX workloads (e.g., application 1364, application 1366, application 1368, and application 1370 in DX workload 1390). DX workloads may have significant number of small triangles. As shown in FIG. 13, the proposed quad compression may result in a significant improvement in ALU utilization. For instance, it can be observed from graph 1300 and graph 1350 that there is a significant reduction in holes as the compression limit increases (e.g., compression 1382 with a limit of 1 and compression 1384 with a limit of 16). The same technique may be used with respect to samples for fragment shading in super-sampling cases. FIG. 13 depicts the percentage of hole reduction for major surfaces in benchmarks. For instance, different benchmarks are being profiled with a different compression limit (e.g., a compression limit of 1, 2, 4, 8, 16, etc.). As the compression limit increases, the respective hardware may need to be increased as well. That is, hardware (e.g., a layer mixer (LM)) may need to be increase as compression limit increases. By considering this trade off, the best results may be a compression limit of 2 and a compression limit of 4.

Aspects herein provide a solution which can be used to gain improvements in quad pixel shading. The techniques herein can be used in hardware as well as software at a GPU. As indicated herein, the problem of underutilization of ALUs in shader processors during quad pixel shading and is aggravated in certain workloads (e.g., API or DX workloads) due to a high volume of small triangles or primitives. Aspects herein propose to compress different quads before scheduling a wave for pixel shading. By doing so, aspects herein may achieve a significant reduction in the amount of holes. Also, aspects herein propose that certain compression limits (e.g., compression limits of 2 and 4) may include favorable results (with respect to effort compared to gains) in which there is a significant gain in hole reduction (e.g., holes reduced by 27.9% and 24.7% in one application for a compression limit of 2 and 4, respectively).

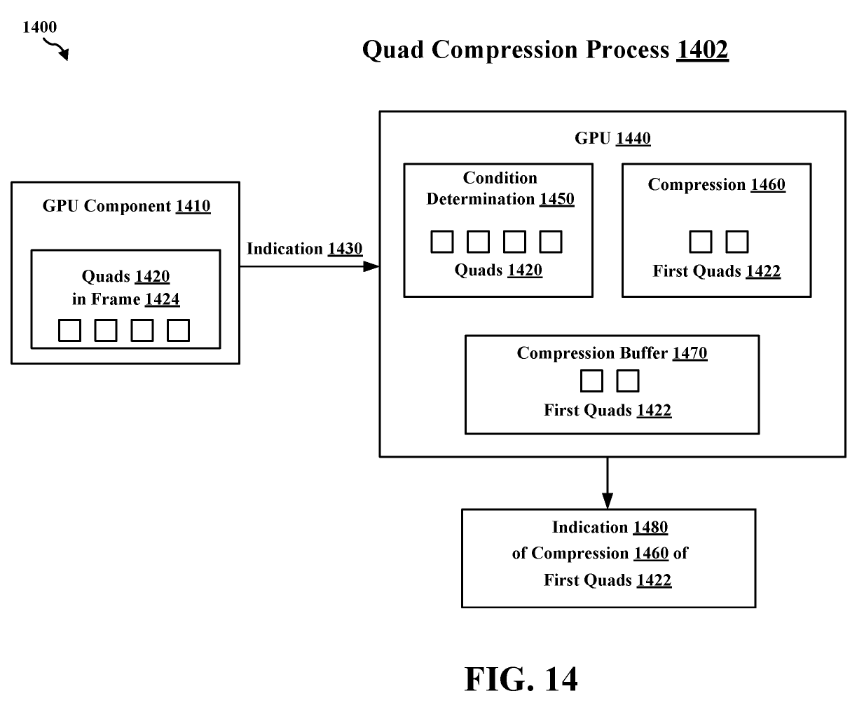

FIG. 14 illustrates diagram 1400 including one example of a quadrant (quad) compression process. More specifically, diagram 1400 depicts an example quad compression process 1402. As shown in FIG. 14, diagram 1400 includes GPU component 1410, quads 1420, first quads 1422, frame 1424, indication 1430, GPU 1440, condition determination 1450, compression 1460, compression buffer 1470, and indication 1480. As depicted in FIG. 14, GPU 1440 may obtain an indication 1430 of a set of quadrants (e.g., quads 1420) for at least one draw call in a set of draw calls associated with a frame 1424, where each of the set of quadrants includes a plurality of pixels in the frame. GPU 1440 may also determine whether each of a set of conditions (e.g., at condition determination 1450) associated with the set of quadrants (e.g., quads 1420) is met, where a compression of at least two quadrants (e.g., first quads 1422) or a refrainment from compression of the at least two quadrants is based on the determination. GPU 1440 may also determine whether to compress the at least two quadrants (e.g., first quads 1422) in the set of quadrants based on each of the set of conditions associated with the set of quadrants being met. The set of conditions may include at least one of: an upcoming quadrant in the set of quadrants belongs to a same position as an existing quadrant in the set of quadrants, a coverage for the upcoming quadrant is not overlapped by the existing quadrant, a coverage for the set of quadrants is unfilled after the compression, the upcoming quadrant is not fully covered, a draw associated with the at least one draw call has not ended, the at least one draw call has not ended, or a compression limit for the set of quadrants is not achieved. Additionally, GPU 1440 may compress (at compression 1460) at least two quadrants (e.g., first quads 1422) in the set of quadrants based on a set of conditions associated with the set of quadrants, or refrain from compressing the at least two quadrants (e.g., first quads 1422) in the set of quadrants based on the set of conditions associated with the set of quadrants. GPU 1440 may also adjust a capacity of at least one memory based on the compression of the at least two quadrants (e.g., first quads 1422) or the refrainment from the compression of the at least two quadrants (e.g., first quads 1422). Moreover, GPU 1440 may configure a compression buffer 1470 based on the compression of the at least two quadrants (e.g., first quads 1422) or the refrainment from the compression of the at least two quadrants. GPU 1440 may also store, in the compression buffer 1470, data for the at least two quadrants (e.g., first quads 1422) based on the compression of the at least two quadrants or the refrainment from the compression of the at least two quadrants. GPU 1440 may also output an indication 1480 of the compression 1460 of the at least two quadrants (e.g., first quads 1422) or the refrainment from the compression of the at least two quadrants (e.g., first quads 1422).

Aspects of the present disclosure may include a number of benefits or advantages. Aspects of the present disclosure may increase the ALU utilization at a GPU. Also, aspects presented herein may reduce the number of holes that are processed by a shader processor. That is, aspects presented herein may decrease the number of workloads that include holes that are processed by a shader processor. By doing so, aspects presented herein may increase the ALU utilization at a shader processor. In order to decrease the number of workloads that include holes, aspects presented herein may compress quads that belong to a same location. For example, aspects herein may compress quads that belong to a same location before scheduling the quads for pixel shading. That is, aspects herein may compress quads that correspond to a same pixel or group of pixels before scheduling the quads for pixel shading. For instance, aspects herein may compress at least two quads together that correspond to a same set of pixels before scheduling the quads for pixel shading. By doing so, aspects presented herein may decrease the number of workloads that include holes that are processed by a shader processor, which increases the ALU utilization at a shader processor. In turn, this may optimize or improve the overall performance of a GPU.

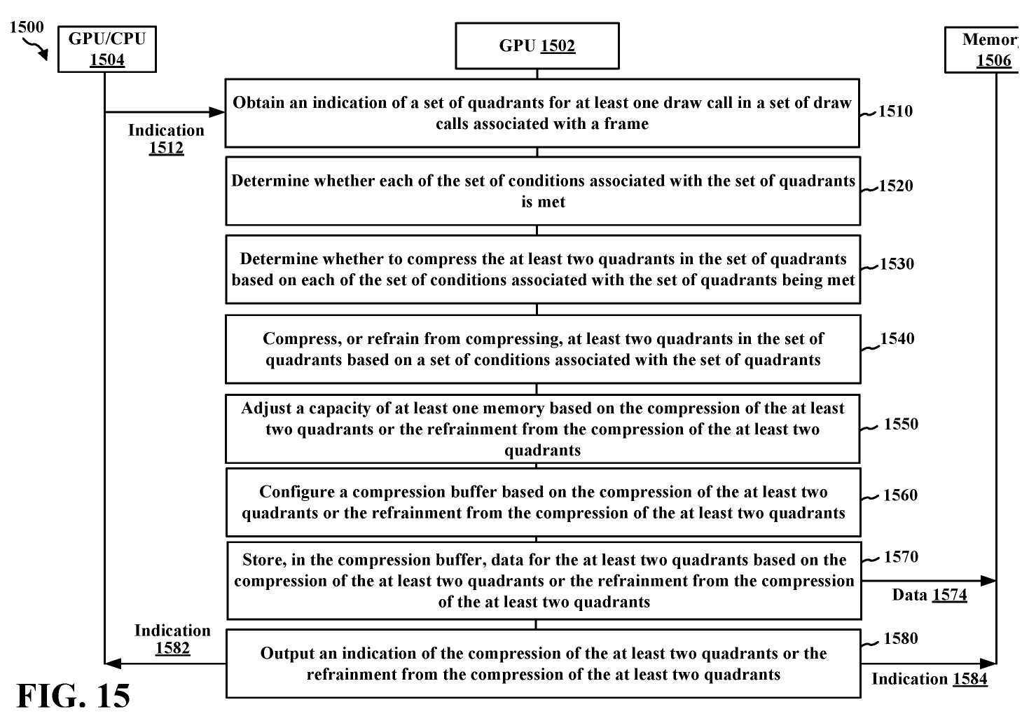

FIG. 15 is a communication flow diagram 1500 of graphics processing in accordance with one or more techniques of this disclosure. As shown in FIG. 15, diagram 1500 includes example communications between GPU 1502 (e.g., a GPU, a GPU component, or another graphics processor), GPU/CPU 1504 (e.g., a GPU, a GPU component, another graphics processor, a compiler, a CPU, a CPU component, or another central processor), and memory 1506 (e.g., a memory, a cache, a system memory, a graphics memory, a memory or cache at a CPU, or a memory or cache at a GPU), in accordance with one or more techniques of this disclosure.

At 1510, GPU 1502 may obtain an indication of a set of quadrants for at least one draw call in a set of draw calls associated with a frame, where each of the set of quadrants includes a plurality of pixels in the frame. For example, GPU 1502 may obtain indication 1512 from GPU/CPU 1504. Also, each of the set of quadrants may be associated with at least one primitive in a plurality of primitives in the frame. Moreover, each of the plurality of pixels in each of the set of quadrants may covered by the at least one primitive, or each of the plurality of pixels in each of the set of quadrants may be uncovered by the at least one primitive. Additionally, each of the set of quadrants may be associated with a pixel shading operation at a graphics processing unit (GPU).

At 1520, GPU 1502 may determine whether each of a set of conditions associated with the set of quadrants is met, where a compression of at least two quadrants or a refrainment from compression of the at least two quadrants is based on the determination. The set of conditions associated with the set of quadrants may be a set of compression conditions associated with the set of quadrants. Also, the set of conditions may include at least one of an upcoming quadrant in the set of quadrants belongs to a same position as an existing quadrant in the set of quadrants, a coverage for the upcoming quadrant is not overlapped by the existing quadrant, a coverage for the set of quadrants is unfilled after the compression, the upcoming quadrant is not fully covered, a draw associated with the at least one draw call has not ended, the at least one draw call has not ended, or a compression limit for the set of quadrants is not achieved. Further, the compression limit for the set of quadrants may be associated with a number of quadrants (N), where N > 1, such that the compression limit is not achieved for N quadrants.

At 1530, GPU 1502 may determine whether to compress the at least two quadrants in the set of quadrants based on each of the set of conditions associated with the set of quadrants being met. In some aspects, determining whether to compress the at least two quadrants based on the set of conditions may comprise determining whether to compress the at least two quadrants based on each of the plurality of pixels in the at least two quadrants being covered or uncovered by at least one primitive in the frame.

At 1540, GPU 1502 may compress at least two quadrants in the set of quadrants based on a set of conditions associated with the set of quadrants, or refrain from compressing the at least two quadrants in the set of quadrants based on the set of conditions associated with the set of quadrants. In some aspects, compressing the at least two quadrants based on the set of conditions may comprise compressing the at least two quadrants based on the set of conditions being met. Also, refraining from compressing the at least two quadrants based on the set of conditions may comprise refraining from compressing the at least two quadrants based on the set of conditions being unmet.

At 1550, GPU 1502 may adjust a capacity of at least one memory based on the compression of the at least two quadrants or the refrainment from the compression of the at least two quadrants. In some aspects, adjusting the capacity of the at least one memory may comprise increasing the capacity of the at least one memory based on the compression of the at least two quadrants or the refrainment from the compression of the at least two quadrants. Also, increasing the capacity of the at least one memory may comprise increasing the capacity of at least one local memory in a shader processor at a graphics processing unit (GPU).

At 1560, GPU 1502 may configure a compression buffer based on the compression of the at least two quadrants or the refrainment from the compression of the at least two quadrants. In some aspects, configuring the compression buffer may comprise configuring the compression buffer at a graphics processing unit (GPU) after a rasterization process and prior to a pixel shading process.

At 1570, GPU 1502 may store, in the compression buffer, data for the at least two quadrants based on the compression of the at least two quadrants or the refrainment from the compression of the at least two quadrants. For example, GPU 1502 may store data 1574 in memory 1506.

At 1580, GPU 1502 may output an indication of the compression of the at least two quadrants or the refrainment from the compression of the at least two quadrants. In some aspects, outputting the indication of the compression of the at least two quadrants or the refrainment from the compression of the at least two quadrants may comprise transmitting the indication of the compression of the at least two quadrants or the refrainment from the compression of the at least two quadrants. For example, GPU 1502 may transmit indication 1582 to GPU/CPU 1504. Also, outputting the indication of the compression of the at least two quadrants or the refrainment from the compression of the at least two quadrants may comprise storing the indication of the compression of the at least two quadrants or the refrainment from the compression of the at least two quadrants. For example, GPU 1502 may store indication 1584 in memory 1506.

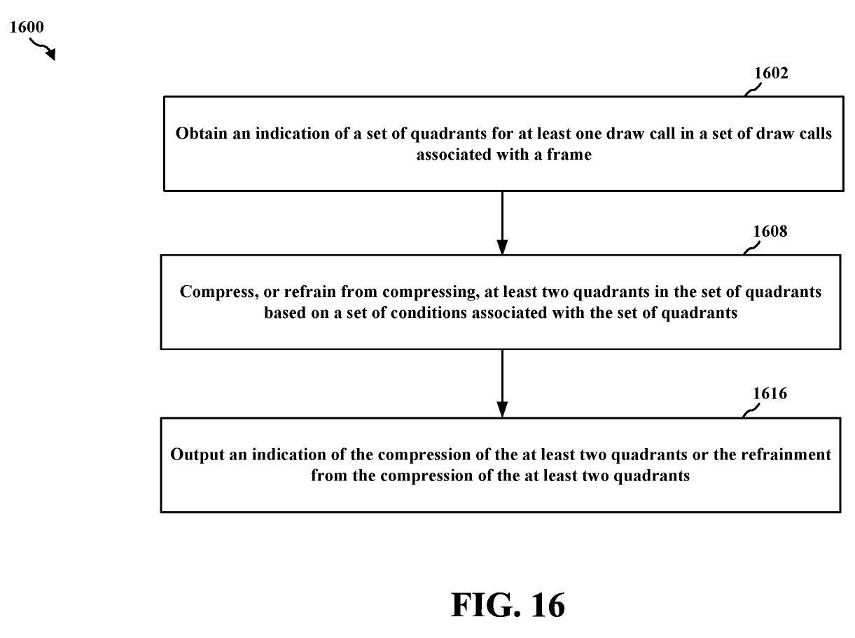

FIG. 16 is a flowchart 1600 of an example method of graphics processing in accordance with one or more techniques of this disclosure. The method may be performed by a GPU (e.g., a GPU, a compiler, a GPU component, another graphics processor, a CPU, a CPU component, or another central processor), a CPU (e.g., a CPU, a compiler, a CPU component, another central processor, a GPU, a GPU component, or another graphics processor), a display driver integrated circuit (DDIC), an apparatus for graphics processing, a wireless communication device, and/or any apparatus that may perform graphics processing as used in connection with the examples of FIGS. 1-15.

At 1602, the GPU may obtain an indication of a set of quadrants for at least one draw call in a set of draw calls associated with a frame, where each of the set of quadrants includes a plurality of pixels in the frame, as described in connection with the examples in FIGS. 1-15. For example, as described in 1510 of FIG. 15, GPU 1502 may obtain an indication of a set of quadrants for at least one draw call in a set of draw calls associated with a frame, where each of the set of quadrants includes a plurality of pixels in the frame. Further, step 1602 may be performed by processing unit 120 in FIG. 1. Also, each of the set of quadrants may be associated with at least one primitive in a plurality of primitives in the frame. Moreover, each of the plurality of pixels in each of the set of quadrants may covered by the at least one primitive, or each of the plurality of pixels in each of the set of quadrants may be uncovered by the at least one primitive. Additionally, each of the set of quadrants may be associated with a pixel shading operation at a graphics processing unit (GPU).

At 1608, the GPU may compress at least two quadrants in the set of quadrants based on a set of conditions associated with the set of quadrants, or refrain from compressing the at least two quadrants in the set of quadrants based on the set of conditions associated with the set of quadrants, as described in connection with the examples in FIGS. 1-15. For example, as described in 1540 of FIG. 15, GPU 1502 may compress at least two quadrants in the set of quadrants based on a set of conditions associated with the set of quadrants, or refrain from compressing the at least two quadrants in the set of quadrants based on the set of conditions associated with the set of quadrants. Further, step 1608 may be performed by processing unit 120 in FIG. 1. In some aspects, compressing the at least two quadrants based on the set of conditions may comprise compressing the at least two quadrants based on the set of conditions being met. Also, refraining from compressing the at least two quadrants based on the set of conditions may comprise refraining from compressing the at least two quadrants based on the set of conditions being unmet.

At 1616, the GPU may output an indication of the compression of the at least two quadrants or the refrainment from the compression of the at least two quadrants, as described in connection with the examples in FIGS. 1-15. For example, as described in 1580 of FIG. 15, GPU 1502 may output an indication of the compression of the at least two quadrants or the refrainment from the compression of the at least two quadrants. Further, step 1616 may be performed by processing unit 120 in FIG. 1. In some aspects, outputting the indication of the compression of the at least two quadrants or the refrainment from the compression of the at least two quadrants may comprise transmitting the indication of the compression of the at least two quadrants or the refrainment from the compression of the at least two quadrants. For example, GPU 1502 may transmit indication 1582 to GPU/CPU 1504. Also, outputting the indication of the compression of the at least two quadrants or the refrainment from the compression of the at least two quadrants may comprise storing the indication of the compression of the at least two quadrants or the refrainment from the compression of the at least two quadrants. For example, GPU 1502 may store indication 1584 in memory 1506.

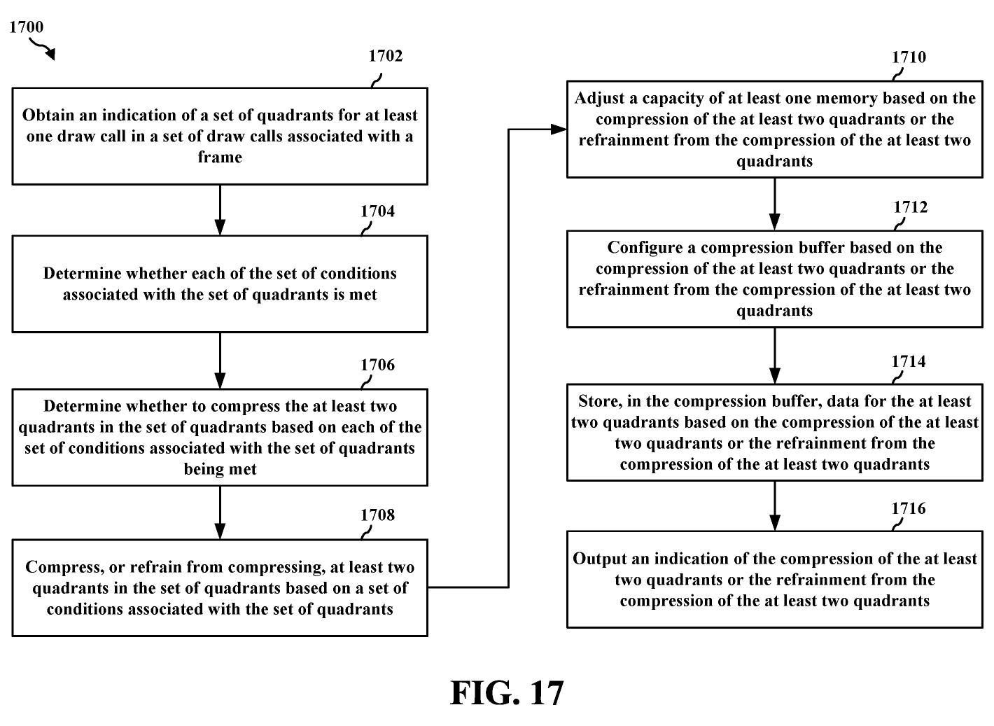

FIG. 17 is a flowchart 1700 of an example method of graphics processing in accordance with one or more techniques of this disclosure. The method may be performed by a GPU (e.g., a GPU, a compiler, a GPU component, another graphics processor, a CPU, a CPU component, or another central processor), a CPU (e.g., a CPU, a compiler, a CPU component, another central processor, a GPU, a GPU component, or another graphics processor), a display driver integrated circuit (DDIC), an apparatus for graphics processing, a wireless communication device, and/or any apparatus that may perform graphics processing as used in connection with the examples of FIGS. 1-15.

At 1702, the GPU may obtain an indication of a set of quadrants for at least one draw call in a set of draw calls associated with a frame, where each of the set of quadrants includes a plurality of pixels in the frame, as described in connection with the examples in FIGS. 1-15. For example, as described in 1510 of FIG. 15, GPU 1502 may obtain an indication of a set of quadrants for at least one draw call in a set of draw calls associated with a frame, where each of the set of quadrants includes a plurality of pixels in the frame. Further, step 1702 may be performed by processing unit 120 in FIG. 1. Also, each of the set of quadrants may be associated with at least one primitive in a plurality of primitives in the frame. Moreover, each of the plurality of pixels in each of the set of quadrants may covered by the at least one primitive, or each of the plurality of pixels in each of the set of quadrants may be uncovered by the at least one primitive. Additionally, each of the set of quadrants may be associated with a pixel shading operation at a graphics processing unit (GPU).

At 1704, the GPU may determine whether each of a set of conditions associated with the set of quadrants is met, where a compression of at least two quadrants or a refrainment from compression of the at least two quadrants is based on the determination, as described in connection with the examples in FIGS. 1-15. For example, as described in 1520 of FIG. 15, GPU 1502 may determine whether each of a set of conditions associated with the set of quadrants is met, where a compression of at least two quadrants or a refrainment from compression of the at least two quadrants is based on the determination. Further, step 1704 may be performed by processing unit 120 in FIG. 1. The set of conditions associated with the set of quadrants may be a set of compression conditions associated with the set of quadrants. Also, the set of conditions may include at least one of an upcoming quadrant in the set of quadrants belongs to a same position as an existing quadrant in the set of quadrants, a coverage for the upcoming quadrant is not overlapped by the existing quadrant, a coverage for the set of quadrants is unfilled after the compression, the upcoming quadrant is not fully covered, a draw associated with the at least one draw call has not ended, the at least one draw call has not ended, or a compression limit for the set of quadrants is not achieved. Further, the compression limit for the set of quadrants may be associated with a number of quadrants (N), where N > 1, such that the compression limit is not achieved for N quadrants.

At 1706, the GPU may determine whether to compress the at least two quadrants in the set of quadrants based on each of the set of conditions associated with the set of quadrants being met, as described in connection with the examples in FIGS. 1-15. For example, as described in 1530 of FIG. 15, GPU 1502 may determine whether to compress the at least two quadrants in the set of quadrants based on each of the set of conditions associated with the set of quadrants being met. Further, step 1706 may be performed by processing unit 120 in FIG. 1. In some aspects, determining whether to compress the at least two quadrants based on the set of conditions may comprise determining whether to compress the at least two quadrants based on each of the plurality of pixels in the at least two quadrants being covered or uncovered by at least one primitive in the frame.

At 1708, the GPU may compress at least two quadrants in the set of quadrants based on a set of conditions associated with the set of quadrants, or refrain from compressing the at least two quadrants in the set of quadrants based on the set of conditions associated with the set of quadrants, as described in connection with the examples in FIGS. 1-15. For example, as described in 1540 of FIG. 15, GPU 1502 may compress at least two quadrants in the set of quadrants based on a set of conditions associated with the set of quadrants, or refrain from compressing the at least two quadrants in the set of quadrants based on the set of conditions associated with the set of quadrants. Further, step 1708 may be performed by processing unit 120 in FIG. 1. In some aspects, compressing the at least two quadrants based on the set of conditions may comprise compressing the at least two quadrants based on the set of conditions being met. Also, refraining from compressing the at least two quadrants based on the set of conditions may comprise refraining from compressing the at least two quadrants based on the set of conditions being unmet.

At 1710, the GPU may adjust a capacity of at least one memory based on the compression of the at least two quadrants or the refrainment from the compression of the at least two quadrants, as described in connection with the examples in FIGS. 1- 15. For example, as described in 1550 of FIG. 15, GPU 1502 may adjust a capacity of at least one memory based on the compression of the at least two quadrants or the refrainment from the compression of the at least two quadrants. Further, step 1710 may be performed by processing unit 120 in FIG. 1. In some aspects, adjusting the capacity of the at least one memory may comprise increasing the capacity of the at least one memory based on the compression of the at least two quadrants or the refrainment from the compression of the at least two quadrants. Also, increasing the capacity of the at least one memory may comprise increasing the capacity of at least one local memory in a shader processor at a graphics processing unit (GPU).

At 1712, the GPU may configure a compression buffer based on the compression of the at least two quadrants or the refrainment from the compression of the at least two quadrants, as described in connection with the examples in FIGS. 1-15. For example, as described in 1560 of FIG. 15, GPU 1502 may configure a compression buffer based on the compression of the at least two quadrants or the refrainment from the compression of the at least two quadrants. Further, step 1712 may be performed by processing unit 120 in FIG. 1. In some aspects, configuring the compression buffer may comprise configuring the compression buffer at a graphics processing unit (GPU) after a rasterization process and prior to a pixel shading process.

At 1714, the GPU may store, in the compression buffer, data for the at least two quadrants based on the compression of the at least two quadrants or the refrainment from the compression of the at least two quadrants, as described in connection with the examples in FIGS. 1-15. For example, as described in 1570 of FIG. 15, GPU 1502 may store, in the compression buffer, data for the at least two quadrants based on the compression of the at least two quadrants or the refrainment from the compression of the at least two quadrants. Further, step 1714 may be performed by processing unit 120 in FIG. 1. For example, GPU 1502 may store data 1574 in memory 1506.

At 1716, the GPU may output an indication of the compression of the at least two quadrants or the refrainment from the compression of the at least two quadrants, as described in connection with the examples in FIGS. 1-15. For example, as described in 1580 of FIG. 15, GPU 1502 may output an indication of the compression of the at least two quadrants or the refrainment from the compression of the at least two quadrants. Further, step 1716 may be performed by processing unit 120 in FIG. 1. In some aspects, outputting the indication of the compression of the at least two quadrants or the refrainment from the compression of the at least two quadrants may comprise transmitting the indication of the compression of the at least two quadrants or the refrainment from the compression of the at least two quadrants. For example, GPU 1502 may transmit indication 1582 to GPU/CPU 1504. Also, outputting the indication of the compression of the at least two quadrants or the refrainment from the compression of the at least two quadrants may comprise storing the indication of the compression of the at least two quadrants or the refrainment from the compression of the at least two quadrants. For example, GPU 1502 may store indication 1584 in memory 1506.

In configurations, a method or an apparatus for graphics processing is provided. The apparatus may be a GPU (or other graphics processor), a CPU (or other central processor), a DDIC, an apparatus for graphics processing, and/or some other processor that may perform data or graphics processing. In aspects, the apparatus may be the processing unit 120 within the device 104, or may be some other hardware within the device 104 or another device. The apparatus, e.g., processing unit 120, may include means for obtaining an indication of a set of quadrants for at least one draw call in a set of draw calls associated with a frame, where each of the set of quadrants includes a plurality of pixels in the frame. The apparatus, e.g., processing unit 120, may also include means for compressing at least two quadrants in the set of quadrants based on a set of conditions associated with the set of quadrants, or refraining from compressing the at least two quadrants in the set of quadrants based on the set of conditions associated with the set of quadrants. The apparatus, e.g., processing unit 120, may also include means for outputting an indication of the compression of the at least two quadrants or the refrainment from the compression of the at least two quadrants. The apparatus, e.g., processing unit 120, may also include means for determining whether each of the set of conditions associated with the set of quadrants is met, where the compression of the at least two quadrants or the refrainment from the compression of the at least two quadrants is based on the determination. The apparatus, e.g., processing unit 120, may also include means for determining whether to compress the at least two quadrants in the set of quadrants based on each of the set of conditions associated with the set of quadrants being met. The apparatus, e.g., processing unit 120, may also include means for adjusting a capacity of at least one memory based on the compression of the at least two quadrants or the refrainment from the compression of the at least two quadrants. The apparatus, e.g., processing unit 120, may also include means for configuring a compression buffer based on the compression of the at least two quadrants or the refrainment from the compression of the at least two quadrants. The apparatus, e.g., processing unit 120, may also include means for storing, in the compression buffer, data for the at least two quadrants based on the compression of the at least two quadrants or the refrainment from the compression of the at least two quadrants.

The subject matter described herein may be implemented to realize one or more benefits or advantages. For instance, the described graphics processing techniques may be used by a GPU, a CPU, a central processor, or some other processor that may perform graphics processing to implement the quad compression techniques described herein. This may also be accomplished at a low cost compared to other graphics processing techniques. Moreover, the graphics processing techniques herein may improve or speed up graphics processing or execution. Further, the graphics processing techniques herein may improve resource or data utilization and/or resource efficiency. Additionally, aspects of the present disclosure may utilize quad compression techniques in order to improve memory bandwidth efficiency and/or increase processing speed at a CPU, a GPU, or a DPU.

It is understood that the specific order or hierarchy of blocks in the processes / flowcharts disclosed is an illustration of example approaches. Based upon design preferences, it is understood that the specific order or hierarchy of blocks in the processes / flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean "one and only one" unless specifically so stated, but rather "one or more." The word "exemplary" is used herein to mean "serving as an example, instance, or illustration." Any aspect described herein as "exemplary" is not necessarily to be construed as preferred or advantageous over other aspects.

Unless specifically stated otherwise, the term "some" refers to one or more and the term "or" may be interpreted as "and/or" where context does not dictate otherwise. Combinations such as "at least one of A, B, or C," "one or more of A, B, or C," "at least one of A, B, and C," "one or more of A, B, and C," and "A, B, C, or any combination thereof' include any combination of A, B, and/or C, and may include multiples of A, multiples of B, or multiples of C. Specifically, combinations such as "at least one of A, B, or C," "one or more of A, B, or C," "at least one of A, B, and C," "one or more of A, B, and C," and "A, B, C, or any combination thereof' may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words "module," "mechanism," "element," "device," and the like may not be a substitute for the word "means." As such, no claim element is to be construed as a means plus function unless the element is expressly recited using the phrase "means for."

In one or more examples, the functions described herein may be implemented in hardware, software, firmware, or any combination thereof. For example, although the term "processing unit" has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term "or" may be interpreted as "and/or" where context does not dictate otherwise. Additionally, while phrases such as "one or more" or "at least one" or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term "processing unit" has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer- readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer- readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term "processor," as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term "processor," as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is an apparatus for graphics processing, including at least one memory and at least one processor coupled to the at least one memory and, based at least in part on information stored in the at least one memory, the at least one processor, individually or in any combination, is configured to: obtain an indication of a set of quadrants for at least one draw call in a set of draw calls associated with a frame, wherein each of the set of quadrants includes a plurality of pixels in the frame; compress at least two quadrants in the set of quadrants based on a set of conditions associated with the set of quadrants, or refrain from compressing the at least two quadrants in the set of quadrants based on the set of conditions associated with the set of quadrants; and output an indication of the compression of the at least two quadrants or the refrainment from the compression of the at least two quadrants.

Aspect 2 is the apparatus of aspect 1, wherein the at least one processor is further configured to: determine whether each of the set of conditions associated with the set of quadrants is met, wherein the compression of the at least two quadrants or the refrainment from the compression of the at least two quadrants is based on the determination.

Aspect 3 is the apparatus of aspect 2, wherein the at least one processor is further configured to: determine whether to compress the at least two quadrants in the set of quadrants based on each of the set of conditions associated with the set of quadrants being met.

Aspect 4 is the apparatus of aspect 3, wherein to determine whether to compress the at least two quadrants based on the set of conditions, the at least one processor is configured to: determine whether to compress the at least two quadrants based on each of the plurality of pixels in the at least two quadrants being covered or uncovered by at least one primitive in the frame.

Aspect 5 is the apparatus of any of aspects 2 to 4, wherein to compress the at least two quadrants based on the set of conditions, the at least one processor is configured to: compress the at least two quadrants based on the set of conditions being met.

Aspect 6 is the apparatus of any of aspects 2 to 5, wherein to refrain from compressing the at least two quadrants based on the set of conditions, the at least one processor is configured to: refrain from compressing the at least two quadrants based on the set of conditions being unmet.

Aspect 7 is the apparatus of any of aspects 2 to 6, wherein the set of conditions associated with the set of quadrants is a set of compression conditions associated with the set of quadrants.

Aspect 8 is the apparatus of any of aspects 1 to 7, wherein the at least one processor is further configured to: adjust a capacity of at least one first memory based on the compression of the at least two quadrants or the refrainment from the compression of the at least two quadrants.

Aspect 9 is the apparatus of aspect 8, wherein to adjust the capacity of the at least one memory, the at least one processor is configured to: increase the capacity of the at least one memory based on the compression of the at least two quadrants or the refrainment from the compression of the at least two quadrants.

Aspect 10 is the apparatus of aspect 9, wherein to increase the capacity of the at least one memory, the at least one processor is configured to: increase the capacity of at least one local memory in a shader processor at a graphics processing unit (GPU).

Aspect 11 is the apparatus of any of aspects 1 to 10, wherein the at least one processor is further configured to: configure a compression buffer based on the compression of the at least two quadrants or the refrainment from the compression of the at least two quadrants.

Aspect 12 is the apparatus of aspect 11, wherein the at least one processor is further configured to: store, in the compression buffer, data for the at least two quadrants based on the compression of the at least two quadrants or the refrainment from the compression of the at least two quadrants.

Aspect 13 is the apparatus of any of aspects 11 to 12, wherein to configure the compression buffer, the at least one processor is configured to: configure the compression buffer at a graphics processing unit (GPU) after a rasterization process and prior to a pixel shading process.

Aspect 14 is the apparatus of any of aspects 1 to 13, wherein the set of conditions includes at least one of: an upcoming quadrant in the set of quadrants belongs to a same position as an existing quadrant in the set of quadrants, a coverage for the upcoming quadrant is not overlapped by the existing quadrant, a coverage for the set of quadrants is unfilled after the compression, the upcoming quadrant is not fully covered, a draw associated with the at least one draw call has not ended, the at least one draw call has not ended, or a compression limit for the set of quadrants is not achieved.

Aspect 15 is the apparatus of aspect 14, wherein the compression limit for the set of quadrants is associated with a number of quadrants (N), where N > 1, such that the compression limit is not achieved for N quadrants.

Aspect 16 is the apparatus of any of aspects 1 to 15, wherein each of the set of quadrants is associated with at least one primitive in a plurality of primitives in the frame.

Aspect 17 is the apparatus of aspect 16, wherein each of the plurality of pixels in each of the set of quadrants is covered by the at least one primitive, or wherein each of the plurality of pixels in each of the set of quadrants is uncovered by the at least one primitive.

Aspect 18 is the apparatus of any of aspects 1 to 17, wherein each of the set of quadrants is associated with a pixel shading operation at a graphics processing unit (GPU).

Aspect 19 is the apparatus of any of aspects 1 to 18, wherein to output the indication of the compression of the at least two quadrants or the refrainment from the compression of the at least two quadrants, the at least one processor is configured to: transmit the indication of the compression of the at least two quadrants or the refrainment from the compression of the at least two quadrants; or store the indication of the compression of the at least two quadrants or the refrainment from the compression of the at least two quadrants.

Aspect 20 is the apparatus of aspect 19, further including (i.e., comprising) at least one of an antenna or a transceiver coupled to the at least one processor, wherein to transmit the indication of the compression of the at least two quadrants or the refrainment from the compression of the at least two quadrants, the at least one processor is configured to: transmit, via at least one of an antenna or a transceiver, the indication of the compression of the at least two quadrants or the refrainment from the compression of the at least two quadrants.

Aspect 21 is the apparatus of any of aspects 1 to 20, wherein the apparatus is a wireless communication device.

Aspect 22 is a method of graphics processing for implementing any of aspects 1 to 20.

Aspect 23 is an apparatus for graphics processing including means for implementing any of aspects 1 to 20.

Aspect 24 is a computer-readable medium (e.g., a non-transitory computer-readable medium) storing computer executable code (e.g., code for graphics processing), the code when executed by at least one processor causes the at least one processor to implement any of aspects 1 to 20.

What is claimed is:

1. An apparatus for graphics processing, comprising:at least one memory; andat least one processor coupled to the at least one memory and, based at least in part on information stored in the at least one memory, the at least one processor is configured to:obtain an indication of a set of quadrants for at least one draw call in a set of draw calls associated with a frame, wherein each of the set of quadrants includes a plurality of pixels in the frame;compress at least two quadrants in the set of quadrants based on a set of conditions associated with the set of quadrants, or refrain from compressing the at least two quadrants in the set of quadrants based on the set of conditions associated with the set of quadrants; andoutput an indication of the compression of the at least two quadrants or the refrainment from the compression of the at least two quadrants.

2. The apparatus of claim 1, wherein the at least one processor is further configured to:determine whether each of the set of conditions associated with the set of quadrants is met, wherein the compression of the at least two quadrants or the refrainment from the compression of the at least two quadrants is based on the determination.

3. The apparatus of claim 2, wherein the at least one processor is further configured to:determine whether to compress the at least two quadrants in the set of quadrants based on each of the set of conditions associated with the set of quadrants being met.

4. The apparatus of claim 3, wherein to determine whether to compress the at least two quadrants based on the set of conditions, the at least one processor is configured to:
determine whether to compress the at least two quadrants based on each of the plurality of pixels in the at least two quadrants being covered or uncovered by at least one primitive in the frame.

5. The apparatus of claim 2, wherein to compress the at least two quadrants based on the set of conditions, the at least one processor is configured to:compress the at least two quadrants based on the set of conditions being met.

6. The apparatus of claim 2, wherein to refrain from compressing the at least two quadrants based on the set of conditions, the at least one processor is configured to:refrain from compressing the at least two quadrants based on the set of conditions being unmet.

7. The apparatus of claim 2, wherein the set of conditions associated with the set of quadrants is a set of compression conditions associated with the set of quadrants.

8. The apparatus of claim 1, wherein the at least one processor is further configured to:adjust a capacity of at least one first memory based on the compression of the at least two quadrants or the refrainment from the compression of the at least two quadrants.

9. The apparatus of claim 8, wherein to adjust the capacity of the at least one memory, the at least one processor is configured to:increase the capacity of the at least one memory based on the compression of the at least two quadrants or the refrainment from the compression of the at least two quadrants.

10. The apparatus of claim 9, wherein to increase the capacity of the at least one memory, the at least one processor is configured to:increase the capacity of at least one local memory in a shader processor at a graphics processing unit (GPU).

11. The apparatus of claim 1, wherein the at least one processor is further configured to:
configure a compression buffer based on the compression of the at least two quadrants or the refrainment from the compression of the at least two quadrants.

12. The apparatus of claim 11, wherein the at least one processor is further configured to:store, in the compression buffer, data for the at least two quadrants based on the compression of the at least two quadrants or the refrainment from the compression of the at least two quadrants.

13. The apparatus of claim 11, wherein to configure the compression buffer, the at least one processor is configured to:configure the compression buffer at a graphics processing unit (GPU) after a rasterization process and prior to a pixel shading process.

14. The apparatus of claim 1, wherein the set of conditions includes at least one of:an upcoming quadrant in the set of quadrants belongs to a same position as an existing quadrant in the set of quadrants,a coverage for the upcoming quadrant is not overlapped by the existing quadrant,a coverage for the set of quadrants is unfilled after the compression,the upcoming quadrant is not fully covered,a draw associated with the at least one draw call has not ended,the at least one draw call has not ended, or a compression limit for the set of quadrants is not achieved.

15. The apparatus of claim 14, wherein the compression limit for the set of quadrants is associated with a number of quadrants (N), where N > 1, such that the compression limit is not achieved for N quadrants.

16. The apparatus of claim 1, wherein each of the set of quadrants is associated with at least one primitive in a plurality of primitives in the frame, and wherein each of the set of quadrants is associated with a pixel shading operation at a graphics processing unit (GPU).

17. The apparatus of claim 16, wherein each of the plurality of pixels in each of the set of quadrants is covered by the at least one primitive, or wherein each of the plurality of pixels in each of the set of quadrants is uncovered by the at least one primitive.

18. The apparatus of claim 1, wherein to output the indication of the compression of the at least two quadrants or the refrainment from the compression of the at least two quadrants, the at least one processor is configured to:transmit the indication of the compression of the at least two quadrants or the refrainment from the compression of the at least two quadrants; or store the indication of the compression of the at least two quadrants or the refrainment from the compression of the at least two quadrants.

19. A method of graphics processing, comprising:obtaining an indication of a set of quadrants for at least one draw call in a set of draw calls associated with a frame, wherein each of the set of quadrants includes a plurality of pixels in the frame;compressing at least two quadrants in the set of quadrants based on a set of conditions associated with the set of quadrants, or refraining from compressing the at least two quadrants in the set of quadrants based on the set of conditions associated with the set of quadrants; andoutputting an indication of the compression of the at least two quadrants or the refrainment from the compression of the at least two quadrants.

20. A computer-readable medium storing computer executable code for graphics processing, the code when executed by at least one processor causes the at least one processor to:obtain an indication of a set of quadrants for at least one draw call in a set of draw calls associated with a frame, wherein each of the set of quadrants includes a plurality of pixels in the frame;compress at least two quadrants in the set of quadrants based on a set of conditions associated with the set of quadrants, or refrain from compressing the at least two quadrants in the set of quadrants based on the set of conditions associated with the set of quadrants; and
output an indication of the compression of the at least two quadrants or the refrainment from the compression of the at least two quadrants.
